(19) United States
(12) Patent Application Publication
(10) Pub. No.: US 2013/0171557 A1
(43) Pub. Date: Jul. 4, 2013

(54) TONER FOR DEVELOPING ELECTROSTATIC IMAGES AND DEVELOPER

(71) Applicants: Naohiro Watanabe, Shizuoka (JP); Tsuyoshi Sugimoto, Shizuoka (JP); Mamoru Hozumi, Miyagi (JP); Osamu Uchinokura, Shizuoka (JP)

(72) Inventors: Naohiro Watanabe, Shizuoka (JP); Tsuyoshi Sugimoto, Shizuoka (JP); Mamoru Hozumi, Miyagi (JP); Osamu Uchinokura, Shizuoka (JP)

(21) Appl. No.: 13/823,385

(22) PCT Filed: Sep. 27, 2011
(86) PCT No.: PCT/JP2011/072718

§ 371 Date: Mar. 14, 2013

(30) Foreign Application Priority Data
Sep. 30, 2010 (JP) 2010-220748
Mar. 18, 2011 (JP) 2011-060296

(51) Int. Cl. G03G 9/087; G03G 9/08

(52) U.S. Cl. CPC G03G 9/08755; G03G 9/081
USPC 430/109.4; 430/137.1; 430/137.14

(57) ABSTRACT

To provide a toner containing: a binder resin containing a non-crystalline polyester resin and a crystalline polyester resin; a colorant; and wax, wherein the toner satisfies the following formula 1, and has loss tangent of 1 or smaller at 80° C. or higher, B−A<20 Formula 1 where A represents a melting point of the crystalline polyester resin and B represents a temperature at which the toner has storage modulus G′ of 20,000 Pa.

### TECHNICAL FIELD

The present invention relates to a toner for developing electrostatic images and a developer containing the toner, both of which are applied in electrophotographic image forming apparatuses such as a photocopier, a printer, and a facsimile machine.

### BACKGROUND ART

Recently, demands in the market include to down size particles diameters of toners for improving image qualities of output images, and to improve low temperature fixing abilities of toners for energy saving.

A toner obtained by the conventional kneading-pulverizing method has irregular shapes with a broad particle size distribution, and it is difficult to obtain smaller particle diameters of a toner by such a method. Moreover, the toner obtained by this method has various problems, including the above, such as high energy requirements for fixing. Especially, during the fixing, the toner produced by the kneading-pulverizing method has a large amount of a releasing agent (wax) present at surfaces of toner particles, as the kneaded product is cracked at the surface of the releasing agent (the wax) by the pulverization to produce the toner particles. For this reason, the releasing effect is enhanced, but the toner tends to deposit on a carrier, a photoconductor, and a blade. Therefore, such the toner does not have satisfactory characteristics on the whole.

In order to solve the aforementioned problems in the kneading-pulverizing method, there has been proposed a production method of a toner by a polymerization method.

The toner produced by this polymerization method can be easily made to have small particle diameters, and has a sharper particle size distribution than that of the toner obtained by the pulverization method, and moreover the wax can be encapsulated in the toner particles.

As the toner production method by such the polymerization method, there has been proposed a production method of a toner, in which an elongation reaction product of a urethane-modified polyester is used as a toner binder to produce a toner having a practical sphericity of 0.90 to 1.00 for the purpose of improving flowing ability, low temperature fixing ability, and hot offset resistance of the toner (see PTL1).

Moreover, there have been disclosed methods for producing a toner, which has excellent powder flow ability, and transfer ability in the case where particle diameters of the toner are reduced, as well as having excellent heat resistance storage stability, low temperature fixing ability, and hot offset resistance of the toner (see PTL2 and PTL3).

Furthermore, there have been disclosed methods of producing a toner, in which a toner binder having a stable molecular weight distribution is produced, and a maturing step is provided for attaining both low temperature fixing ability and offset resistance of the toner (see PTL4 and PTL5).

There has been also disclosed a method where crystalline polyester is introduced by a polymerization method for improving low temperature fixing ability of a toner. As a preparation method of a crystalline polyester dispersion liquid, for example, PTL6 discloses a preparation method of a dispersion liquid using a solvent for phase separation. By this proposed method, however, only a coarse dispersion liquid having a dispersed particle diameter of several tens micrometers to several hundreds micrometers is obtained. This method cannot yield a dispersion liquid having a volume average particle diameter of 1.0 μm or smaller, which can be used for the production of the toner. Moreover, in PTL7, reduction of particle diameters of a toner is attempted by mixing crystalline polyester alone into a solvent and heating and cooling the mixture, for the purpose attaining reduced particle diameters of dispersed crystalline polyester in a dispersion liquid. The resulting dispersion liquid is however not stable, and hence is not satisfactory.

For the purpose of improve fixing ability and storage stability of a toner, PTL8 discloses a toner containing a crystalline resin whose melting point is higher than the temperature, at which the toner has the loss modulus G″ of 1,000 Pa, by 5° C. to 10° C. However, it is not sufficient to solve the problems mentioned above.

The toner production methods proposed in PTL1, PTL2, and PTL3 include a step of increasing molecular weights, in which polyester prepolymer containing an isocyanate group is subjected to a polyaddition reaction with amines in a reaction system where an organic solvent and an aqueous medium are mixed.

In the case of the aforementioned methods and toners obtained by such methods, hot offset resistance of the resulting toner improves, but low temperature fixing ability thereof is degraded, and glossiness of an image after fixing reduces. Therefore, these toners do not yet have sufficient fixing abilities enough to be used in an image forming apparatus

Furthermore, the toner production methods disclosed in PTL4 and PTL5 can be easily employed to a polycondensation reaction, which is a high temperature reaction, but cannot be employed to the aforementioned reaction system where the organic solvent and the aqueous medium are mixed, unless various conditions are optimized.

Although the crystalline polyester resin is introduced by the polymerization method in PTL6 and PTL7 for improving the low temperature fixing ability of the toner, the dispersion liquid having small particle diameters cannot be stably obtained. As a result, undesirable toner particle size distribution is provided, and moreover the crystalline polyester resin is extruded onto surfaced of toner particles, which causes filming. Therefore, these are not sufficient.

### CITATION LIST

### Patent Literature

PTL 1 Japanese Patent Application Laid-Open (JP-A) No. 11-133665
PTL 2 JP-A No. 2002-287400
PTL 3 JP-A No. 2002-351143
PTL 4 Japanese Patent (JP-B) No. 2579150
PTL 5 JP-A No. 2001-158819
PTL 6 JP-A No. 08-176310
PTL 7 JP-A No. 2005-15589
PTL 8 JP-A No. 2009-134007

### SUMMARY OF INVENTION

### Technical Problem

The present invention aims to provide a toner for developing electrostatic images, which has stable low temperature fixing ability and hot offset resistance without causing, and heat resistance storage stability, as well as providing a developer containing the toner.

### Solution to Problem

The means for solving the problem mentioned above are as follow:

<1> A toner containing:

a binder resin containing a non-crystalline polyester resin and a crystalline polyester resin;

a colorant; and

wax,

wherein the toner satisfies the following formula 1, and has loss tangent of 1 or smaller at 80° C. or higher,

B−A<20 Formula I

where A represents a melting point of the crystalline polyester resin and B represents a temperature at which the toner has storage modulus G′ of 20,000 Pa.

<2> The toner according to <1>, wherein the crystalline polyester resin is contained in an amount of 1 part by mass to 15 parts by mass relative to 100 parts by mass of the binder resin.
<3> The toner according to any of <1> or <2>, wherein the toner is obtained by the method containing:

dispersing, in an aqueous medium, an oil phase in which at least the binder resin containing the crystalline polyester resin and the non-crystalline polyester resin is contained in an organic solvent, to prepare an O/W dispersion liquid; and

removing the organic solvent from the O/W dispersion liquid.

<4> The toner according to <3>, wherein the toner is obtained by the method containing:

dispersing, in the aqueous medium containing a dispersant, the oil phase in which at least the colorant, the wax, the crystalline polyester resin, a compound containing an active hydrogen group, and a binder resin precursor having a site reactive with the compound containing an active hydrogen group are dissolved or dispersed in the organic solvent, to prepare an emulsified dispersion liquid;

allowing the binder resin precursor and the compound containing an active hydrogen group to react in the emulsified dispersion liquid; and

removing the organic solvent from the emulsified dispersion liquid.

<5> The toner according to <1>, wherein the toner is obtained by the method containing:

melting and kneading a toner material containing the binder resin, the crystalline polyester resin, the colorant, and the wax to prepare a melt-kneaded product;

pulverizing the melt-kneaded product to prepare a pulverized product; and

classifying the pulverized product,

wherein the method further comprises annealing at temperature that is an onset temperature ±5° C., where the onset temperature is calculated from a DSC curve of the crystalline polyester resin as measured by a differential scanning calorimeter with elevating temperature.

<6> The toner according to <1>, wherein the toner is obtained by the method containing:

dispersing the crystalline polyester resin, and the non-crystalline polyester resin, respectively in separate aqueous media to emulsify the crystalline polyester resin and the non-crystalline polyester resin as crystalline polyester resin particles, and non-crystalline polyester resin particles, respectively;

mixing the crystalline polyester resin particles, the non-crystalline polyester resin particles, a wax agent dispersion liquid in which the releasing agent is dispersed, and a colorant dispersion liquid in which the colorant is dispersed, to prepare an aggregated particle dispersion liquid in which aggregated particles are dispersed;

fusing and cohering the aggregated particles to form toner particles; and

washing the toner particles.

<7> The toner according to <6>, wherein the method further contains annealing at a temperature that is an onset temperature ±5° C., where the onset temperature is calculated from a DSC curve of the crystalline polyester resin as measured by a differential scanning calorimeter with elevating temperature.
<8> The toner according to any one of <1> to <7>, wherein the crystalline polyester resin has a melting point of 60° C. to 80° C.
<9> The toner according to any one of <1> to <8>, wherein the toner satisfies the following relational expressions:

10 mgKOH/g<X<40 mgKOH/g

0 mgKOH/g<Y<20 mgKOH/g

20 mgKOH/g<X+Y<40 mgKOH/g

where X represents an acid value of the crystalline polyester resin, and Y represents a hydroxyl value of the crystalline polyester resin.

<10> The toner according to any one of <1> to <9>, wherein the toner satisfies the following relational expression:

−10 mgKOH/g<X−Z<10 mgKOH/g

where X represents an acid value of the crystalline polyester resin, and Z represents an acid value of the non-crystalline polyester resin.

<11> The toner according to any one of <1> to <10>, wherein the crystalline polyester resin is prepared from a C4-C12 saturated dicarboxylic acid, and a C4-C12 saturated diol.
<12> The toner according to any one of <1> to <11>, wherein a proportion of the crystalline polyester resin having a number average molecular weight of 500 or smaller is 0% to 2.0% of the crystalline polyester resin, and a proportion of the crystalline polyester resin having a number average molecular weight of 1,000 or smaller is 0% to 4.0% of the crystalline polyester resin, where the number average molecular weight of the crystalline polyester resin is measured by GPC.
<13> The toner according to any one of <1> to <12>, wherein the wax has a melting point of 70° C. to 90° C.
<14> The toner according to any one of <1> to <13>, wherein the wax is microcrystalline wax.
<15> A developer, containing:

the toner as defined in any one of <1> to <14>.

### Advantageous Effects of Invention

The present invention provides a toner for developing electrostatic images, which has stable low temperature fixing ability and hot offset resistance without causing, and heat resistance storage stability, and provides a developer containing the toner.

### BRIEF DESCRIPTION OF DRAWING

FIG. 1 is a graph for explaining onset temperature of a crystalline polyester resin.

### DESCRIPTION OF EMBODIMENTS

### (Toner)

The toner of the present invention contains a binder resin, a colorant, and wax, and may further contain other components, if necessary.

### <Binder Resin>

The binder resin contains at least a non-crystalline polyester resin and a crystalline polyester resin.

The crystalline polyester resin generally has sharp melt properties, and has excellent low temperature fixing ability. When the crystalline polyester resin is used alone as the binder resin of the toner, however, production ability and moreover flow ability of a resulting toner become poor due to the characteristics of the crystalline polyester resin. Therefore, an amount of the crystalline polyester resin for use in the toner is preferably 1 part by mass to 15 parts by mass relative to 100 parts by mass of the binder resin.

When the amount of the crystalline polyester resin is smaller than 1 part by mass, the resulting toner may have poor low temperature fixing ability. When the amount thereof is greater than 15 parts by mass, the resulting toner may have poor flow ability.

For attaining the low temperature fixing ability, storage stability, and hot offset resistance of the toner at the same time, the toner satisfies the following formula 1, where A represents a melting point of the crystalline polyester resin, and B represents a temperature at which the storage modulus G′ of the toner becomes 20,000 Pa.

B−A<20 Formula 1

When the melting point of the crystalline polyester resin is lower by 20° C. than the temperature at which the storage modulus G′ becomes 20,000 Pa, and the loss tangent of the toner is 1 or smaller at 80° C. or higher, the non-crystalline polyester resin is softened at the temperature at which the crystalline polyester resin melts, so that the crystalline polyester resin and the binder resin containing the non-crystalline polyester resin are compatible to each other, which results in excellent low temperature fixing ability of the resulting toner. When the difference in the temperatures is larger than 20° C., or the loss tangent is larger than 1 at 80° C. or higher, the non-crystalline polyester resin is not softened at the temperature at which the crystalline polyester resin melts, and this may results in poor low temperature fixing ability of the resulting toner.

In order to achieve the melting point of the crystalline polyester resin that is lower than the temperature, at which the storage modulus G′ of the toner becomes 20,000 Pa, by 20° C. or lower, and the loss tangent of 1 or smaller at 80° C. or higher, the melting point of the crystalline polyester resin is preferably 60° C. to 80° C. When the melting point of the crystalline polyester resin is lower than 60° C., the resulting toner may have poor heat resistance storage stability. When the melting point thereof is higher than 80° C., the resulting toner may have poor low temperature fixing ability.

Moreover, the non-crystalline polyester resin preferably contains a high molecular weight component and a low molecular weight component.

By adjusting the proportions of the high molecular weight component and low molecular weight component of the non-crystalline polyester resin, it is possible for the toner to have the melting point of the crystalline polyester resin that is lower than the temperature, at which the storage modulus G′ of the toner becomes 20,000 Pa, by 20° C. or lower, and the loss tangent of 1 or smaller at 80° C. or higher.

Note that, the storage modulus G′ is a value indicating the elasticity of the material, and loss modulus G″ is a value indicating the viscosity of the material.

The loss tangent (tan δ), which is a ratio between the storage modulus G′ and the loss modulus G″, is a value G″/G′ obtained by dividing the loss modulus G″ by the storage modulus G′, and indicates a ratio of the viscosity to the elasticity.

The storage modulus G′ and loss modulus G″ of a resin having high meltability, such as the binder resin of the toner, generally have high dependency to temperature. In the present invention, therefore, the storage modulus G′ and loss modulus G″ are measured by vibrating the kneaded product in the melted state with changing the temperature while the angular frequency and the strain amount are kept constant at 6.28 rad/sec, and 0.3%, respectively.

In order to use the crystalline polyester resin in a pulverized toner that has been conventionally known in the art, it is desirable to perform annealing. In the production of the pulverized toner, the crystalline polyester resin and the non-crystalline polyester resin are melted and kneaded. By the melt-kneading, the crystalline polyester resin and the non-crystalline polyester resin become compatible to each other, which improves the low temperature fixing ability, but the resulting toner has poor heat resistance storage stability. By performing an annealing, a phase separation between the crystalline polyester resin and the non-crystalline polyester resin is progressed.

As the toner, not only the pulverized toner, a chemical toner can be also used.

On the toner obtained by the emulsification aggregation method, which is the chemical toner, however, it is preferred that annealing be performed. In the emulsification aggregation method, the toner can be obtained by emulsifying or dispersing the toner material in water, aggregating and heating the resulting emulsified or dispersed elements. Since the heating is performed at the temperature which is around the melting point of the binder resin used, the crystalline polyester resin and the non-crystalline polyester resin become a compatible state, and therefore, similarly to the case of the pulverized toner, both desirable heat resistance storage stability and low temperature fixing ability cannot be attained at the same time. For this reason, it is desirable to perform annealing.

In the case where the crystalline polyester resin and the non-crystalline polyester resin is used for obtaining a toner in the method in which the toner material for forming a toner that is one of chemical toners is dissolved in an organic solvent, and the resulting solution is emulsified or dispersed in water, the crystalline polyester resin is preferably dispersed in the organic solvent at low temperature.

Generally, the crystalline polyester resin dispersed in the organic solvent gives high viscosity. This is not very problematic at a laboratory experimental scale, but causes such a problem at a mass-production scale that stirring or fluid feeding cannot be carried out. To counter this problem, the non-crystalline polyester resin can be added to reduce the viscosity. In the case where the crystalline polyester resin and the non-crystalline polyester resin are mixed and then dispersed in the organic solvent, they become a compatible state, if the temperature is high. In this case, similar to the case of the pulverized toner, the resulting toner cannot achieve both the desirable heat resistance storage stability and low temperature fixing ability.

Therefore, when the crystalline polyester resin and the non-crystalline polyester resin are mixed and dispersed in the organic solvent, it is desirable to sufficiently cool the system during the dispersing. The cooling temperature during the dispersing is lower than the onset temperature in the DSC measurement of the crystalline polyester resin by 10° C. or more. Similarly, when the organic solvent used is removed, the temperature is lower than the onset temperature in the DSC measurement of the crystalline polyester resin by 10° C. or more. The onset temperature of the crystalline polyester resin can be measured by the following method.

### <Measurement Method of Onset Temperature of Crystalline Polyester Resin>

The onset temperature is determined specifically in the following manner. As a measuring device, TA-60WS and DSC-60 of Shimadzu Corporation are used, and the measurement is performed under the following measurement conditions.

### [Measurement Conditions]

Sample container: aluminum sample pan (with a lid)

Amount of sample: 5 mg

Reference: aluminum sample pan (housing 10 mg of alumina)

Atmosphere: nitrogen (flow rate of 50 mL/min)

Temperature condition

Starting temperature: 20° C.

Temperature increase rate: 10° C./min

Finish temperature: 150° C.

Retention Time: None

Temperature decrease rate: 10° C./min

Finish temperature: 20° C.

Retention time: None

Temperature increase rate: 10° C./min

Finish temperature: 150° C.

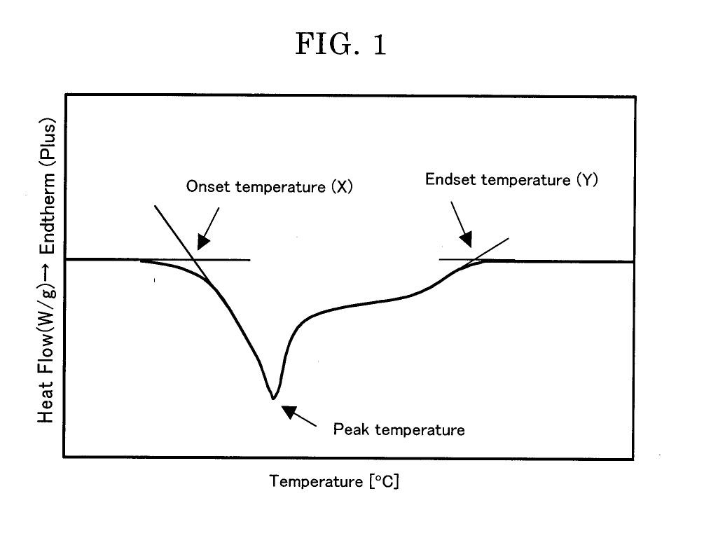

The measured results are analyzed using a data analysis software (TA-60, version 1.52) of Shimadzu Corporation. The onset temperature means a temperature at the intersection between the base line and a tangent line drawn at the point at which a peak curve of the endothermic peak derived from the endothermic peak of the crystalline polyester resin gives the maximum derivative (see FIG. 1).

### <Organic Solvent>

The organic solvent is preferably an organic solvent, which can dissolve the crystalline polyester resin completely at high temperature to form a uniform solvent, and can cause a phase separation with the crystalline polyester resin once cooled to form an opaque heterogeneous solution. Examples of the organic solvent include toluene, ethyl acetate, butyl acetate, methyl ethyl ketone, and methyl isobutyl ketone. These may be used independently, or in combination.

Since the crystalline polyester resin in the toner has high crystallinity, the toner has such thermofusion properties that the toner decreases its viscosity largely at around the fixing onset temperature. Specifically, the toner has excellent heat resistance stability doe to the crystallinity of the crystalline polyester resin just under the melting onset temperature, and decreases its viscosity largely (exhibiting sharp melting properties) at the melting onset temperature to be fixed. Therefore, the toner having both excellent heat resistance storage stability and low temperature fixing ability can be obtained. Moreover, such the toner also has excellent fusing latitude (i.e. a range between the lowest fixing temperature and the hot offset temperature.

The crystalline polyester resin and non-crystalline polyester resin are preferably compatible to each other at least at part thereof. The compatibility of these polymers contributes to the improvement of the low temperature fixing ability and hot offset resistance of the resulting toner. To make them compatible to each other, the alcohol component and carboxylic acid component constituting the non-crystalline polyester resin and the alcohol component and carboxylic acid component constituting the crystalline polyester resin are preferably identical or similar.

### <Crystalline Polyester Resin>

The crystalline polyester resin can be synthesized from an alcohol component, such as a C2-C12 saturated diol compound (e.g. 1,4-butanediol, 1,6-hexanediol, 1,8-octanediol, 1,10-decanediol, 1,12-dodecanediol, and derivatives thereof), and an acid component including at least a C2-C12 dicarboxylic acid having a double bond (C═C), or a C2-C12 saturated carboxylic acid (e.g. fumaric acid, 1,4-butanedioic acid, 1,6-hexanedioic acid, 1,8-octanedioic acid, 1,10-decanedioic acid, 1,12-dodecanedioic acid, and derivatives thereof).

Among them, the crystalline polyester resin consisted of the saturated C4-C12 diol component selected from 1,4-butanediol, 1,6-hexanediol, 1,8-octanediol, 1,10-decanediol, and 1,12-dodecanediol, and the saturated C4-C12 dicarboxylic acid component selected from 1,4-butanedioic acid, 1,6-hexanedioic acid, 1,8-octanedioic acid, 1,10-decanedioic acid, and 1,12-dodecanedioic acid is particularly preferable because the resulting crystalline polyester resin has high crystallinity and shows drastic viscosity change at around the melting point thereof.

As a results of the researches conducted by the present inventors for giving a toner with a low temperature fixing ability and heat resistance storage stability, it has been found that both low temperature fixing ability and heat resistance storage stability of the toner can be attained by using the crystalline polyester resin having the melting point of 60° C. to 80° C. When the melting point of the crystalline polyester resin is lower than 60° C., the heat resistance storage stability of the resulting toner is poor. When the melting point thereof is higher than 80° C., the low temperature fixing ability of the resulting toner is poor.

As a method for controlling the crystallinity and softening point of the crystalline polyester resin, there is a method in which a trihydric or higher polyhydric alcohol such as glycerin is added to the alcohol component and tri or higher valent polycarboxylic acid such as trimellitic anhydride is added to the acid component to proceed to a condensation polymerization to yield a non-linear polyester, and such the non-linear polyester is designed and used during the synthesis of polyester.

The molecular structure of the crystalline polyester resin can be confirmed by X-ray diffraction, GC/MS, LC/MS, and IR measurements, as well as NMR of a solution or solid thereof. A simple method is that the molecular structure thereof is confirmed by an infrared absorption spectrum thereof having an absorption originated from δCH (out-of-plane deformation vibration) of olefin at 965 cm⁻¹±10 cm⁻¹ or 990 cm⁻¹±10 cm⁻¹.

Regarding the molecular weight of the crystalline polyester resin, the crystalline polyester resin with a sharp molecular weight distribution and low molecular weights has excellent low temperature fixing ability, and the crystalline polyester resin having a large amount of low molecular weight crystalline polyester molecules has poor heat resistance storage stability. Therefore, it has been found that when the weight average molecular weight thereof is preferably 5,000 to 20,000 in the molecular weight distribution as measured by GPC of the o-dichlorobenzene soluble component, a proportion of the crystalline polyester resin having the number average molecular weight of 500 or smaller is 0% to 2.5%, and a proportion of the crystalline polyester resin having the number average molecular weight of 1,000 or smaller is 0% to 5.0% relative to the entire crystalline polyester resin, both low temperature fixing ability, and heat resistance storage stability can be achieved at the same time. It is more preferred that the proportion thereof having the number average molecular weight Mn of 500 or smaller be 0% to 2.0%, and the proportion thereof having the Mn of 1,000 or smaller be 0% to 4.0%.

Given that the acid value of the crystalline polyester resin is defined as X and the hydroxyl value of the crystalline polyester resin is defined as Y, the crystalline polyester resin preferably satisfies the following relational expressions:

10 mgKOH/g<X<40 mgKOH/g

0 mgKOH/g<Y<20 mgKOH/g

20 mgKOH/g<X+Y<40 mgKOH/g

When the acid value of the crystalline polyester resin is 10 mgKOH/g or lower, the resulting toner has poor compatibility to paper, which is a recording member, and this may result in poor heat resistance storage stability.

When the acid value of the crystalline polyester resin is 40 mgKOH/g or higher, or the hydroxyl value of the crystalline polyester resin is 20 mgKOH/g or lower, the resulting toner may have poor charging ability in the high temperature high humidity environment.

When the sum of the acid value and hydroxyl value thereof is 20 mgKOH/g or lower, the crystalline polyester resin has low compatibility to the non-crystalline polyester resin, this may result in insufficient low temperature fixing ability of the toner. When the sum of the acid value and hydroxyl value thereof is 40 mgKOH/g or higher, the compatibility between the crystalline polyester resin and the non-crystalline polyester resin is excessively high, the resulting toner may have poor heat resistance storage stability.

The solubility of the crystalline polyester resin to the organic solvent of 70° C. is preferably 10 parts by mass or more. When the solubility thereof is less than 10 parts by mass, the compatibility between the organic solvent and the crystalline polyester resin is poor, and therefore it is difficult to disperse the crystalline polyester resin to the size of submicron order in the organic solvent. As a result, the crystalline polyester resin is unevenly present in the toner, this may result poor charging ability of the toner, or poor image quality of images formed with the resulting toner after long period of use.

The solubility of the crystalline polyester resin to the organic solvent of 20° C. is preferably less than 3.0 parts by mass. When the solubility thereof is 3.0 parts by mass or more, the crystalline polyester resin dissolved in the organic solvent tends to be compatible to the non-crystalline polyester resin even before heating, this may result poor resistance storage stability of the resulting toner, contaminations of the developing unit, and deterioration in qualities of images formed with the resulting toner.

### <Non-Crystalline Polyester Resin>

In the present invention, the non-crystalline polyester resin is contained as the binder resin component. As the non-crystalline polyester resin, a non-crystalline unmodified polyester resin is preferably used.

Note that, a modified polyester resin obtained by a crosslink and/or elongation reaction of a binder resin precursor formed of the modified polyester resin, details of which will be described later, and the unmodified polyester resin are preferably compatible to each other at least at part thereof. The compatibility of these resins contributes to the improvement of the low temperature fixing ability and hot offset resistance of the resulting toner. To make them compatible to each other, the alcohol component and carboxylic acid component constituting the modified polyester resin and the alcohol component and carboxylic acid component constituting the unmodified polyester resin are preferably identical or similar.

The alcohol component for use in the non-crystalline polyester resin is, for example, dihydric alcohol (diol). Specific examples thereof include: C2-C36 alkylene glycol (e.g. ethylene glycol, 1,2-propylene glycol, 1,3-propylene glycol, 1,4-butylene glycol, and 1,6-hexanediol); C4-C36 alkylene ether glycol (e.g. diethylene glycol, triethylene glycol, dipropylene glycol, polyethylene glycol, polypropylene glycol, and polybutylene glycol); C6-C36 alicyclic diol (e.g. 1,4-cyclohexanedimethanol, and hydrogenated bisphenol A); C2-C4 alkylene oxide [e.g. ethylene oxide (may be abbreviated as EO hereinafter), propylene oxide (may be abbreviated as PO hereinafter) and butylene oxide (may be abbreviated as BO hereinafter)] adduct (added mole number of 1 to 30) of the foregoing alicyclic diol; and C2-C4 alkylene oxide (e.g. EO, PO, and BO) adduct (added mole number of 2 to 30) of bisphenols (e.g. bisphenol A, bisphenol F, and bisphenol S).

Moreover, as the alcohol component, tri or higher polyhydric (e.g. trihydric to octahydric, or higher polyhydric) alcohol component may be contained in addition to the dihydric alcohol (diol). Specific examples thereof include: C3-C36 aliphatic tri- to octa- or higher polyhydric alcohol (e.g., alkane polyol and intramolecular or intermolecular dehydration products thereof, such as glycerin, triethylol ethane, trimethylol propane, pentaerythritol, sorbitol, sorbitan, polyglycerin, and dipentaerythritol; and saccharides and derivatives thereof such as sucrose, and methyl glucoside); C2-C4 alkylene oxide (e.g. EO, PO, and BO) adduct (added mole number of 1 to 30) of the foregoing aliphatic polyhydric alcohol; C2-C4 alkylene oxide (e.g. EO, PO, and BO) adduct (added mole number of 2 to 30) of trisphenols (e.g. trisphenol PA); and C2-C4 alkylene oxide (e.g. EO, PO, and BO) adduct (added mole number of 2 to 30) of novolac resins (e.g. phenol novolac, and cresol novolac, average polymerization degree of 3 to 60).

As the carboxylic acid component for use in the non-crystalline polyester resin, divalent carboxylic acid (dicarboxylic acid) is used. Specific examples thereof include: C4-C36 alkane dicarboxylic acid (e.g. succinic acid, adipic acid, and sebacic acid), and C4-C36 alkenyl succinic acid (e.g. dodecenyl succinic acid); C4-C36 alicyclic dicarboxylic acid, such as dimmer acid (linoleic acid dimer); C4-C36 alkene dicarboxylic acid (e.g. maleic acid, fumaric acid, citraconic acid, and mesaconic acid); and C8-C36 aromatic dicarboxylic acid (e.g. phthalic acid, isophthalic acid, terephthalic acid, and derivatives thereof, and naphthalene dicarboxylic acid).

Among them, the C4-C20 alkene dicarboxylic acid and the C8-C20 aromatic dicarboxylic acid are particularly preferable. As the dicarboxylic acid, acid anhydrides or lower alkyl (C1-C4) esters (e.g. methyl ester, ethyl ester, and isopropyl ester) of the above-listed dicarboxylic acids can be used.

In addition to the divalent carboxylic acid, a tri or higher (trivalent to hexavalent, or higher) polyhydric carboxylic acid component may be contained. Specific examples thereof include: C9-C20 aromatic polycarboxylic acid (e.g. trimellitic acid, and pyromellitic acid); and vinyl polymers of saturated carboxylic acids [number average molecular weight (Mn), measured by gel permeation chromatography (GPC):450 to 10,000], such as styrene-maleic acid copolymer, styrene-acrylic acid copolymer, α-olefin-maleic acid copolymer, and styrene-fumaric acid copolymer. Among them, the C9-C20 aromatic polycarboxylic acid is preferable, and trimellitic acid, and pyromellitic acid are particularly preferable. As the tri or higher polycarboxylic acid, acid anhydrides or lower alkyl (C1-C4) esters (e.g. methyl ester, ethyl ester, and isopropyl ester) of the above-listed polycarboxylic acids can be used.

An acid value of the unmodified polyester resin is generally 1 mgKOH/g to 50 mgKOH/g, preferably 5 mgKOH/g to 30 mgKOH/g. When the acid value of the unmodified polyester resin is within the range above, the toner tends to be negatively charged as the acid value thereof is 1 mgKOH/g or higher, and the compatibility between the toner and paper improves during fixing of the toner image on the paper, which improves low temperature fixing ability. When the acid value thereof is higher than 50 mgKOH/g, the charge stability of the resulting toner is impaired, especially by the fluctuation of the environmental conditions. Therefore, the unmodified polyester resin for use in the present invention preferably has the acid value of 1 mgKOH/g to 50 mgKOH/g. Moreover, the unmodified polyester resin preferably has a hydroxyl value of 5 mgKOH/g or higher.

Given that the acid value of the crystalline polyester resin is defined as X and the acid value of the non-crystalline polyester resin is defined as Z, the crystalline polyester resin and the non-crystalline polyester resin preferably satisfy the relational expression:

−10 mgKOH/g<X−Z<10 mgKOH/g,

When the value deducted the acid value of the non-crystalline polyester resin from that of the crystalline polyester resin is 10 mgKOH/g or more, the crystalline polyester resin and the non-crystalline polyester resin may have poor compatibility to each other, this may result poor low temperature fixing ability of the resulting toner. In addition, the crystalline polyester resin tends to be extruded onto a surface of the toner particle, this may result the contamination of the developing unit, or filming.

### <Binder Resin Precursor>

The binder resin component preferably contains a binder resin precursor.

The toner of the present invention is preferably a toner obtained by the method containing: dispersing, in an aqueous medium containing a dispersant, an oil phase which contains an organic solvent, and at least a colorant, a releasing agent, the crystalline polyester resin, a compound containing an active hydrogen group, and the binder resin precursor having a site reactive with the compound containing an active hydrogen are dissolved or dispersed in the organic solvent, to prepare an emulsified dispersion liquid; allowing the binder resin precursor and the compound containing an active hydrogen to react in the emulsified dispersion liquid; and removing the organic solvent from the emulsified dispersion liquid.

The mass ratio of the unmodified polyester to the binder resin precursor is generally 70/30 to 95/5, preferably 75/25 to 90/10, and more preferably 80/20 to 88/12. When the mass ratio of the unmodified polyester resin is greater than 95%, the resulting toner may have poor hot offset resistance and heat resistance storage stability, and may cause image failures as used in the high temperature high humidity environment. When the mass ratio of the unmodified polyester resin is smaller than 70%, the resulting toner may have poor low temperature fixing ability. As the mass of the unmodified polyester resin is small, the loss tangent of the toner is small. As the mass of the unmodified polyester is large, the loss tangent of the toner is large.

The binder resin precursor is, for example, polyester prepolymer modified with isocyanate, or epoxy, or the like. The polyester prepolymer reacts with a compound having an active hydrogen group (e.g. amines) to proceed to an elongation reaction, and use thereof improves fusing latitude (i.e. a range between the lowest fixing temperature and the hot offset temperature). As a synthesis method of the polyester prepolymer, the polyester prepolymer can be easily synthesized by reacting, with a polyester resin (base reactant), an isocyanating agent, an epoxidizing agent, etc. which are conventionally known.

Examples of the isocyanating agent include: aliphatic polyisocyanate (e.g., tetramethylene diisocyanate, hexamethylene diisocyanate, and 2,6-diisocyanate methyl caproate); alicyclic polyisocyanate (e.g. isophorone diisocyanate, and cyclohexylmethane diisocyanate); aromatic diisocyanate (e.g. tolylene diisocyanate, and diphenylmethane diisocyanate); aromatic aliphatic diisocyanate (e.g. α,α,α′,α′-tetramethyl xylylene diisocyanate); isocyanurates; the polyisocyanates mentioned above, each of which is blocked with a phenol derivative, oxime, caprolactam, or the like; and a combination of any of those listed. These may be used independently, or in combination.

Examples of the epoxidizing agent include epichlorohydrin.

A ratio of the isocyanating agent is determined as an equivalent ratio [NCO]/[OH] of the isocyanate group [NCO] to the hydroxyl group [OH] of the polyester as a base, and the equivalent ratio [NCO]/[OH] is generally 5/1 to 1/1, preferably 4/1 to 1.2/1, and more preferably 2.5/1 to 1.5/1. When the equivalent ratio [NCO]/[OH] is larger than 5/1, the resulting toner may have low temperature fixing ability. When the molar ratio of [NCO] is smaller than 1, the urea content of the polyester prepolymer is low, and therefore the resulting toner may have poor hot offset resistance.

An amount of the isocyanating agent in the polyester prepolymer is generally 0.5% by mass to 40% by mass, preferably 1% by mass to 30% by mass, and more preferably 2% by mass to 20% by mass. The amount of the isocyanating agent is smaller than 0.5% by mass, the hot-offset resistance of the resulting toner is poor, and it may be disadvantageous in attaining both the heat resistance storage stability and the low temperature fixing ability. When the amount thereof is greater than 40% by mass, the low temperature fixing ability of the resulting toner may be poor.

Moreover, the number of the isocyanate groups per molecule of the polyester prepolymer is generally 1 or more, preferably 1.5 to 3 on average, and more preferably 1.8 to 2.5 on average. When the number of the isocyanate groups per molecule is less than 1, the molecular weight of the urea-modified polyester resin after the elongation reaction is small, this may result poor hot-offset resistance of the resulting toner.

The weight average molecular weight Mw of the binder resin precursor is preferably 1×10⁴ to 3×10⁵.

### <Compound Containing Active Hydrogen Group>

The compound containing an active hydrogen group is typically amines. Examples of the amines include a diamine compound, a tri or higher polyamine compound, an amino alcohol compound, an aminomercaptan compound, an amino acid compound, and the preceding compounds whose amino group is blocked.

Examples of the diamine compound include: aromatic diamine (e.g. phenylene diamine, diethyl toluene diamine, and 4,4′-diaminodiphenyl methane); alicyclic diamine (e.g. 4,4′-diamino-3,3′-dimethyldichlorohexyl methane, diamine cyclohexane, and isophorone diamine); and aliphatic diamine (e.g. ethylene diamine, tetramethylene diamine, and hexamethylene diamine).

Examples of the tri or higher polyamine compound include diethylene triamine, and triethylene tetramine.

Examples of the amino alcohol compound include ethanol amine, and hydroxyethyl aniline.

Examples of the aminomercaptan compound include aminoethylmercaptan, and aminopropylmercaptan.

Examples of the amino acid compound include amino propionic acid, and amino caproic acid.

Examples of the compound whose amino group is blocked include an oxazolidine compound and ketimine compound derived from the amines and ketones (e.g., acetone, methyl ethyl ketone and methyl isobutyl ketone). Among these amines, the diamine compound alone, or a mixture of the diamine compound and a small amount of the polyamine compound is preferable.

Note that, the urea-modified polyester resin can be used in combination with, other than the unmodified polyester resin, a polyester resin modified with a chemical bond excluding a urea bond, such as a polyester resin modified with a urethane bond.

### <Colorant>

The colorant is appropriately selected from dyes and pigments known in the art without any restriction, and examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinone blue, fast violet B, methylviolet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and a mixture thereof. These may be used independently, or in combination.

An amount of the colorant is generally 1% by mass to 15% by mass, preferably 3% by mass to 10% by mass, relative to the toner.

The colorant may be used in the form of a master batch in which the colorant forms a composite with a resin. The resin used for production of the master batch or kneaded together with the master batch includes the modified polyester resin, and non-modified polyester resin mentioned above. Other examples of the resin include: styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes; epoxy resins; epoxy polyol resins; polyurethane resins; polyamide resins; polyvinyl butyrals; polyacrylic acid resins; rosin; modified rosin; terpene resins; aliphatic or alicyclic hydrocarbon resins; aromatic petroleum resins; chlorinated paraffin; and paraffin wax. These may be used independently, or in combination.

The master batch can be prepared by mixing or kneading a colorant with the resin for use in the master batch through application of high shearing force. Preferably, an organic solvent may be used for improving the interactions between the colorant and the resin. Further, a so-called flashing method is preferably used, since a wet cake of the colorant can be directly used, i.e., no drying is required. Here, the flashing method is a method in which an aqueous paste containing a colorant is mixed or kneaded with a resin and an organic solvent, and then the colorant is transferred to the resin to remove the water and the organic solvent. In this mixing or kneading, for example, a high-shearing disperser (e.g., a three-roll mill) is preferably used.

### <Wax>

The wax for use in the toner is preferably wax having a melting point of 50° C. to 120° C., more preferably 70° C. to 90° C.

Since the wax can effectively act as a releasing agent at the interface between a fixing roller and the toner, hot offset resistance of the toner can be improved without applying a releasing agent, such as oil, to the fixing roller.

The melting point of the wax is determined by measuring the maximum endothermic peak using a differential scanning calorimeter, TG-DSC system TAS-100 (manufactured by Rigaku Corporation).

Examples of the wax include: wax such as vegetable wax (e.g. carnauba wax, cotton wax, Japan wax, and rice wax); animal wax (e.g., bees wax and lanolin); mineral wax (e.g., ozokelite and ceresin); and petroleum wax (e.g., paraffin wax, microcrystalline wax and petrolatum).

Examples of the wax other than the natural wax listed above include: synthetic hydrocarbon wax (e.g., Fischer-Tropsch wax and polyethylene wax); and synthetic wax (e.g., ester wax, ketone wax and ether wax).

Further examples include fatty acid amides such as 1,2-hydroxystearic acid amide, stearic amide, phthalic anhydride imide and chlorinated hydrocarbons; low-molecular-weight crystalline polymer resins such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain.

### <Charge Controlling Agent>

The charge controlling agent is appropriately selected from any conventional materials used as a charge controlling agent depending on the intended purpose without any restriction. Examples of the charge controlling agent include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, and metal salts of salicylic acid derivatives.

As the charge controlling agent, commercial products can be used, and examples of such commercial products include: BONTRON 03 (nigrosine dye), BONTRON P-51 (quaternary ammonium salt), BONTRON S-34 (metal azo-containing dye), E-82 (oxynaphthoic acid-based metal complex), E-84 (salicylic acid-based metal complex) and E-89 (phenol condensate), all manufactured by ORIENT CHEMICAL INDUSTRIES CO., LTD; TP-302 and TP-415 (quaternary ammonium salt molybdenum complexes) both manufactured by Hodogaya Chemical Co., Ltd.; COPY CHARGE PSY VP 2038 (quaternary ammonium salt), COPY BLUE PR (triphenylmethane derivative), COPY CHARGE NEG VP2036 and COPY CHARGE NX VP434 (quaternary ammonium salts), all manufactured by Hoechst AG; LRA-901 and LR-147 (boron complexes), both manufactured by Japan Carlit Co., Ltd.; copper phthalocyanine; perylene; quinacridone; azo pigments; and polymeric compounds having, as a functional group, a sulfonic acid group, carboxyl group, quaternary ammonium salt, etc. These may be used independently, or in combination.

An amount of the charge controlling agent for use is determined depending on the binder resin for use, presence of optionally used additives, and the production method of the toner including the dispersing method, and thus cannot be determined unconditionally. It is, however, preferably 0.1 parts by mass to 10 parts by mass, more preferably 0.2 parts by mass to 5 parts by mass relative to 100 parts by mass of the binder resin. When the amount of the charge controlling agent is greater than 10 parts by mass, the electrostatic propensity of the resulting toner is excessively large, which reduces the effect of charge controlling agent. As a result, the electrostatic suction force toward the developing roller may increase, which may cause poor flowing ability of the developer, and low image density. The charge controlling agent may be added by dissolving and dispersing after fusing and kneading together with the master batch and the resin, or added by dissolving or dispersing directly in the organic solvent, or added by fixing on a surface of each toner particle after the preparation of the toner particles.

### <External Additive>

The toner of the present invention may contain an external additive to aid flowing ability, developing ability, and electrostatic propensity of the toner.

As the external additive, inorganic particles are preferably used.

The primary particle diameter of the inorganic particles is preferably 5 nm to 2 more preferably 5 nm to 500 nm. Moreover, the specific surface area of the inorganic particles as determined by the BET method is preferably 20 m²/g to 500 m²/g.

An amount of the inorganic particles is preferably 0.01% by mass to 5% by mass, more preferably 0.01% by mass to 2.0% by mass, relative to the toner.

The inorganic particles are appropriately selected depending on the intended purpose without any restriction. Examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. These may be used independently, or in combination.

Other examples of the external additive include polymer particles, such as particles produced by soap-free emulsification polymerization, suspension polymerization, or dispersion polymerization (e.g. polystyrene particles, (meth)acrylatic acid ester copolymer particles); polymer particles produced by polymerization condensation such as silicone particles, benzoguanamine particles, and nylon particles; and polymer particles of thermoset resins.

The flow improving agent is an agent capable of performing a surface treatment on the toner particles to improve hydrophobic properties of the toner so that the degradations of the toner in the flow properties or charging characteristics are prevented in the high humidity environment. Examples of the flow improving agent include a silane coupling agent, a sililating agent, a fluoroalkyl group-containing silane coupling agent, an organic titanate-based coupling agent, an aluminum-based coupling agent, silicone oil, and modified silicone oil.

The cleaning improving agent is added to the toner for removing the developer remaining on a photoconductor or a primary transfer member. Examples thereof include: metal salts of fatty acid (e.g. stearic acid), such as zinc stearate, and calcium stearate; polymer particles produced by soap-free emulsification polymerization, such as polymethyl methacrylate particles, and polystyrene particles. The polymer particles preferably have a relatively narrow particle size distribution, particularly preferably the volume average particle diameter of 0.01 μm to 1 μm.

### <Production Method of Polyester Resin>

In the case where the toner material contains a modified polyester resin such as a urea-modified polyester resin, the modified polyester resin can be produced by a one-shot method, or the like.

As one example, a production method of a urea-modified polyester resin will be explained hereinafter.

At first, polyol and polycarboxylic acid are heated to 150° C. to 280° C. in the presence of a catalyst such as tetrabutoxy titanate, and dibutyl tin oxide, optionally removing generated water under the reduced pressure, to thereby yield a polyester resin containing a hydroxyl group. Next, the polyester resin containing a hydroxyl group and polyisocyanate are allowed to react at 40° C. to 140° C., to yield polyester prepolymer containing an isocyanate group. Then, the polyester prepolymer containing an isocyanate group and amines are allowed to react at 0° C. to 140° C. to yield a urea-modified polyester resin.

A number average molecular weight of the urea-modified polyester resin is preferably 1,000 to 10,000, more preferably 1,500 to 6,000.

Note that, a solvent is optionally used for the reaction between the polyester resin containing a hydroxyl group and the polyisocyanate, and the reaction between the polyester prepolymer containing an isocyanate group and the amines.

The solvent is appropriately selected depending on the intended purpose without any restriction. Examples thereof include inert compounds to the isocyanate group, such as aromatic solvents (e.g. toluene, and xylene), ketones (e.g. acetone, methyl ethyl ketone, and methyl isobutyl ketone), esters (e.g. ethyl acetate), amides (e.g. dimethylformamide, and dimethylacetoamide), and ethers (e.g. tetrahydrofuran).

In the case where the unmodified polyester resin is used in combination with the modified polyester resin, an unmodified polyester resin produced in the same manner as the production of the polyester resin containing a hydroxyl group may be added to a solution after the reaction to yield the urea-modified polyester resin.

The binder resin component contained in the oil phase may contain the crystalline polyester resin, the non-crystalline polyester resin, the binder resin precursor, and the unmodified polyester resin in combination.

The binder resin component preferably contains a polyester resin, more preferably contains the polyester resin in an amount of 50% by mass or more. When the amount of the polyester resin is less than 50% by mass, the resulting toner may have poor low temperature fixing ability. It is particularly preferred that the entire binder resin component be formed of the polyester resin (including the crystalline polyester resin, non-crystalline polyester resin, modified polyester resin etc.).

Moreover, the binder resin component may further contain other resins.

Examples of the resins contained in the binder resin component other than the polyester resin include: styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes; epoxy resins; epoxy polyol resins; polyurethane resins; polyamide resins; polyvinyl butyrals; polyacrylic acid resins; rosin; modified rosin; terpene resins; aliphatic or alicyclic hydrocarbon resins; aromatic petroleum resins; chlorinated paraffin; and paraffin wax. These may be used independently, or in combination.

### <Dissolution and Recrystallization Method of Crystalline Polyester Resin in Organic Solvent>

A method of dissolving and recrystallizing the crystalline polyester resin in the organic solvent is as follows.

A crystalline polyester resin (10 g) and an organic solvent (90 g) are stirred for 1 hour at 70° C.

The solution obtained after the stirring is cooled over 12 hours at 20° C. to thereby recrystallize the crystalline polyester resin.

The dispersion liquid, in which the recrystallized crystalline polyester resin is dispersed in the organic solvent, is introduced into KIRIYAMA funnel (manufactured by Kiriyama Glass Co., Ltd.) where filter paper No. 4 (manufactured by Kiriyama Glass Co., Ltd.) for KIRIYAMA funnel is set, and is subjected to suction filtration by an aspirator, to separate into the organic solvent and the crystalline polyester resin. The crystalline polyester resin obtained by the separation is dried for 48 hours at 35° C., to thereby yield the recrystallized crystalline polyester resin.

### <Evaluation of Solubility of Crystalline Polyester Resin to Organic Solvent>

The solubility of the crystalline polyester resin to the organic solvent is determined by the following method.

A crystalline polyester resin (20 g) and an organic solvent (80 g) are stirred for 1 hour at the predetermined temperature.

The solution obtained from the stirring is introduced into KIRIYAMA funnel (manufactured by Kiriyama Glass Co., Ltd.) where filter paper No. 4 (manufactured by Kiriyama Glass Co., Ltd.) for KIRIYAMA funnel is set, and is subjected to suction filtration by an aspirator at the predetermined temperature, to separate into the organic solvent and the crystalline polyester resin. The organic solvent obtained after the separation is heated for 1 hour at the temperature that is the boiling point of the organic solvent+50° C. to evaporate the organic solvent. Based on the change in the weight before and after the heating, the amount of the crystalline polyester resin dissolved in the organic solvent is calculated.

In the present invention, the acid value is measured by the method specified in JIS K0070-1992.

Specifically, at first, 0.5 g of a sample (0.3 g of the ethyl acetate soluble component) is added to 120 mL of toluene, and the mixture is stirred at about 10 hours at 23° C. to thereby dissolve the sample. To this, 30 mL of ethanol is further added to thereby prepare a sample solution. When the sample is not dissolved, a solvent such as dioxane, and tetrahydrofuran is used. Then, an acid value of the sample is measured at 23° C. by means of a potentiometric automatic titrator DL-53 (product of Mettler-Toledo K.K.) and an electrode DG113-SC (product of Mettler-Toledo K.K.), and the result is analyzed using an analysis software LabX Light Version 1.00.000.

For the calibration of the device, a mixed solvent of toluene (120 mL) and ethanol (30 mL) is used.

The measurement conditions for this are the same as those in the measurement of the hydroxyl value.

The acid value can be measured in the manner described above, but specifically, the sample solution is titrated with a pre-standardized 0.1N potassium hydroxide/alcohol solution and then the acid value is calculated from the titration value based on the following formula:

Acid value [KOHmg/g]=titration value [mL]×N×56.1 [mg/mL]/mass of sample [g] (N is a factor of 0.1N potassium hydroxide/alcohol solution)

For the measurement of the fine powder of the toner, a flow particle image analyzer (FPIA-2100, manufactured by Sysmex Corporation) is used, and an analysis is performed using an analysis software (FPIA-2100 DataProcessing Program for FPIA version00-10). Specifically, a 100 mL glass beaker is charged with 0.1 mL to 0.5 mL of a 10% by mass surfactant (alkylbenzene sulfonate, Neogen SC-A, manufactured by Dai-Ichi Kogyo Seiyaku Co., Ltd.), and to this 0.1 g to 0.5 g of each toner is added and stirred by microspartel, followed by adding 80 mL of ion-exchanged water. The obtained dispersion liquid is dispersed with an ultrasonic wave disperser (manufactured by Honda Electronics Co., Ltd.) for 3 minutes. The obtained dispersion liquid is subjected to the measurement for determining the shapes and particle diameter distribution of the toner by means of FPIA-2100 until the concentration becomes 5,000 particles per microliter to 15,000 particles per microliter.

In this measurement method, it is important that the concentration is set to 5,000 particles per microliter to 15,000 particles per microliter in light of the measurement reproducibility of the average sphericity. In order to attain the concentration of the dispersion liquid as mentioned, an amount of a surfactant to be added, or an amount of the toner to be added is changed. The amount of the surfactant varies depending on the hydrophobicity of the toner, similarly to the measurement of the toner particle diameter earlier. When a large amount of the surfactant is used, noise occurs due to the generated foam. When a small amount of the surfactant is used, the toner cannot be sufficiently made wet, which may result in insufficient dispersion. The amount of the toner added varies depending on the particle diameter of the toner. When the particle diameter thereof is small, the amount of the toner added is small. When the particle diameter thereof is large, a large amount of the toner is added. In the case where the particle diameter of the toner added is 3 μm to 7 μm, 0.1 g to 0.5 g of the toner is added so that the dispersion concentration of 5,000 particles per microliter to 15,000 particles per microliter can be attained.

### (Properties of Toner)

The acid value of the toner of the present invention is an important index for the low temperature fixing ability and hot offset resistance of the toner, and is derived from a terminal carboxyl group of an unmodified polyester resin. The acid value of the toner is preferably 0.5 mgKOH/g to 40 mgKOH/g in order to control the low temperature fixing ability (e.g. lowest fixing temperature, and hot offset temperature).

When the acid value is higher than 40 mgKOH/g, the elongation reaction and/or crosslink reaction of the modified polyester resin proceeds insufficiently, and this may result poor hot offset resistance of the toner. When the acid value thereof is lower than 0.5 mgKOH/g, conversely, such an effect of the base that dispersion stability is improved may not be attained during the production of the toner, or the elongation reaction and/or crosslink reaction of the modified polyester resin tends to be accelerated, which may lower the production stability.

The glass transition temperature Tg1st of the toner is preferably 45° C. to 65° C., more preferably 50° C. to 60° C. Use of the toner having the glass transition temperature in this range can achieve low temperature fixing ability, heat resistance storage stability, and high fastness. When the Tg1st of the toner is lower than 45° C., blocking may occur within a developing unit, or filming may occur on a photoconductor. When the Tg1st of the toner is higher than 65° C., low temperature fixing ability of the toner may be poor. When the Tg1st of the toner is 50° C. to 60° C., more preferable outcomes can be expected.

The endothermic shoulder temperature Tg2nd of the toner is preferably 20° C. to 40° C. When the Tg2nd of the toner is lower than 20° C., blocking may occur within a developing unit, or filming may occur on a photoconductor. When the Tg2nd of the toner is higher than 40° C., low temperature fixing ability of the toner may be poor.

### <Method for Producing Toner in Aqueous Medium>

As the aqueous medium, water may be used alone, or in combination with a solvent miscible with water. Examples of the solvent miscible with water include alcohols (e.g. methanol, isopropanol, and ethylene glycol), dimethylformamide, tetrahydrofuran, cellosolves (e.g. methyl cellosolve), and lower ketones (e.g. acetone, and methyl ethyl ketone).

By reacting the reactive modified polyester, such as the polyester prepolymer containing an isocyanate group (A) with the amine (B) in the aqueous medium, urea-modified polyester or the like can be obtained. As a method for stably forming dispersed elements each formed of the reactive modified polyester such as the modified polyester (e.g. urea-modified polyester) and prepolymer (A) in the aqueous medium, there is a method in which a composition of a toner containing the reactive modified polyester such as the modified polyester (e.g. urea-modified polyester) and prepolymer (A) to the aqueous medium, and dispersing the toner material by a shear force. The reactive modified polyester such as the prepolymer (A) and other materials for the composition of the toner (may also referred to as a “toner material”) such as a colorant, a colorant master batch, a releasing agent, a charge controlling agent, a unmodified polyester, and the like may be added at the time when dispersed elements are formed in the aqueous medium. It is, however, more preferred that these materials be mixed in advance to form a toner material (i.e. a composition of the toner) and the toner material be added and dispersed in the aqueous medium. Moreover, the toner material including the colorant, releasing agent, charge controlling agent and the like is not necessarily added at the time when particles are formed in the aqueous medium, and may be added after particles are formed. For example, the colorant is added in the conventional dying method after forming particles without including the colorant.

The dispersion method is appropriately selected depending on the intended purpose without any restriction, and examples thereof include conventional dispersers such as a low-speed shearing disperser, a high-speed shearing disperser, a friction disperser, a high-pressure jetting disperser and ultrasonic wave disperser. Among them, the high-speed shearing disperser is preferable for giving dispersed elements of 2 μm to 20 μm in the diameter.

In use of the high-speed shearing disperser, the rotating speed is appropriately selected depending on the intended purpose without any restriction, but is generally 1,000 rpm to 30,000 rpm, preferably 5,000 rpm to 20,000 rpm. The duration for dispersing is appropriately selected depending on the intended purpose without any restriction, but in the case of the batch system, it is generally 0.1 minutes to 5 minutes. The temperature during the dispersing is generally 0° C. to 150° C. (in a pressurized state), preferably 40° C. to 98° C. Higher the temperature during the dispersing is lower the viscosity of the resulting dispersion liquid of the urea-modified polyester and prepolymer (A), and hence is preferable because of easiness in dispersing.

An amount of the aqueous medium is generally 50 parts by mass to 2,000 parts by mass, preferably 100 parts by mass to 1,000 parts by mass, relative to 100 parts by mass of the toner material including the polyester such as the urea-modified polyester and prepolymer (A). When the amount of the aqueous medium is smaller than 50 parts by mass, the toner material may not be in a desirable dispersed state, and thus toner particles of the predetermined particle diameters may not be obtained. When the amount of the aqueous medium is larger than 2,000 parts by mass, it is not economically desirable.

Moreover, a dispersant is optionally used for the dispersing. Use of the dispersant is preferable as a sharp particle size distribution of the dispersed particles can be attained, and the dispersed state is stably maintained.

Various dispersants are used for emulsifying and dispersing the oil phase, in which the toner material is dispersed, contained in the aqueous medium. Examples of the dispersant include a surfactant, an inorganic particle dispersant, and a polymer particle dispersant.

Examples of the surfactant include: anionic surfactants such as alkylbenzenesulfonic acid salts, α-olefin sulfonic acid salts and phosphoric acid esters; cationic surfactants such as amine salts (e.g., alkyl amine salts, amino alcohol fatty acid derivatives, polyamine fatty acid derivatives and imidazoline), and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Preferable examples of the fluoroalkyl group-containing anionic surfactant include fluoroalkyl carboxylic acid having 2 to 10 carbon atoms and metal salts thereof, disodium perfluorooctanesulfonylglutamate, sodium 3-[ω-fluoroalkyl(C6-C11)oxy)-1-alkyl(C3-C4)sulfonate, sodium 3-[ω-fluoroalkanoyl(C6-C8)-N-ethylamino]-1-propanesulfonate, fluoroalkyl(C11-C20) carboxylic acid and metal salts thereof, perfluoroalkylcarboxylic acid(C7-C13) and metal salts thereof, perfluoroalkyl(C4-C12)sulfonate and metal salts thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonylglycin and monoperfluoroalkyl(C6-C16)ethylphosphate.

Examples of the commercial product of the fluoroalkyl group-containing anionic surfactant include: SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of Dainippon Ink and Chemicals, Inc.); EFTOP EF-102, 103, 104, 105, 112, 123A, 123B, 306A, 501, 201 and 204 (these products are of Tohchem Products Co., Ltd.); and FUTARGENT F-100 and F150 (these products are of NEOS COMPANY LIMITED).

Examples of the cationic surfactant include fluoroalkyl group-containing primary, secondary or tertiary aliphatic compounds, aliphatic quaternary ammonium salts (e.g., perfluoroalkyl (C6-C10) sulfonamide propyltrimethylammonium salts), benzalkonium salts, benzetonium chloride, pyridinium salts and imidazolinium salts. Commercial names thereof are, for example, SURFLON S-121 (product of Asahi Glass Co., Ltd.); FRORARD FC-135 (product of Sumitomo 3M Ltd.); UNIDYNE DS-202 (product of Daikin Industries, Ltd.); MEGAFACE F-150 and F-824 (these products are of Dainippon Ink and Chemicals, Inc.); EFTOP EF-132 (product of Tohchem Products Co., Ltd.); and FUTARGENT F-300 (product of Neos COMPANY LIMITED).

Moreover, poorly water-soluble inorganic dispersing agents, such as tricalcium phosphate, calcium carbonate, titanium oxide, colloidal silica, and hydroxyapatite, can also used as the dispersing agent.

It has been confirmed that polymer particles have the same effect as the inorganic dispersing agent. Examples of the polymer particles include MMA polymer particles (1 μm, and 3 μm), styrene particles (0.5 μm, and 2 μm), and styrene-acrylonitrile polymer particles (1 μm). Specific examples thereof include PB-200H manufactured by Kao Corporation, SGP manufactured by (manufactured by Soken Chemical & Engineering Co., Ltd.), Techpolymer SB (manufactured by Sekisui Plastics Co., Ltd.), SGP-3G (manufactured by Soken Chemical & Engineering Co., Ltd.), and Micropearl (manufactured by Sekisui Chemical Co., Ltd.).

Furthermore, a polymeric protective colloid or water-insoluble organic particles may be used to stabilize dispersed droplets. Examples of the water-insoluble organic particles include: acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing (meth)acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide), vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate); acrylamide, methacrylamide, diacetone acrylamide and methylol compounds of thereof; acid chlorides (e.g., acrylic acid chloride and methacrylic acid chloride); nitrogen-containing compounds and nitrogen-containing heterocyclic compounds (e.g., vinyl pyridine, vinyl pyrrolidone, vinyl imidazole and ethyleneimine); polyoxyethylenes (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose).

By stirring the obtained emulsified dispersion liquid and cohering the emulsified dispersion elements (the reaction product) at the temperature lower than the glass transition temperature of the resin by a certain range, in the certain organic solvent concentration range, fused particles can be produced. Then, the entire system is gradually heated in a stirred state of a laminar flow for removing the organic solvent, to take place the removal of solvent, to thereby produce irregularly shaped toner particles. In the case where calcium phosphate or the like that is soluble in acid and alkali is used as a dispersion stabilizer, the calcium phosphate is dissolved by acid such as hydrochloric acid, followed by washing with water, to thereby remove the calcium phosphate from the particles. Alternatively, it can be removed by decomposition using enzyme.

In the case where the dispersant is used, the dispersant may be stay remained on surfaces of the toner particles.

In order to decrease the viscosity of the dispersion liquid containing the toner material, a solvent in which the polyester such as the urea-modified polyester and the prepolymer (A) can be dissolved, can be used. Use of the solvent is preferred from the viewpoint of attaining a sharp particle size distribution.

The solvent used is preferably a volatile solvent having a boiling point of lower than 100° C., since removal of the solvent can be easily performed. Examples of the solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used independently, or in combination. Among them, the aromatic solvent such as the toluene and xylene, and the halogenated hydrocarbon such as 1,2-dichloroethane, chloroform, and carbon tetrachloride are particularly preferable.

An amount of the solvent used relative to 100 parts by mass of the prepolymer (A) is generally 0 parts by mass to 300 parts by mass, preferably 0 parts by mass to 100 parts by mass, and more preferably 25 parts by mass to 70 parts by mass.

When the solvent is used, the solvent is removed from the reactant obtained after the elongation and/or crosslink reaction of the modified polyester (prepolymer) with the amine under normal pressure or reduced pressure.

The duration of the elongation and/or crosslink reaction is selected, for example, depending on reactivity between the isocyanate group contained in the prepolymer (A) for use and the amine (B) for use, but it is generally 10 minutes to 40 hours, preferably 2 hours to 24 hours. The reaction temperature is generally 0° C. to 150° C., preferably 40° C. to 98° C. Moreover, a conventional catalyst may be used, if necessary. Specific examples of the catalyst include dibutyl tin laurate, and dioctyl tin laurate. As the elongating agent and/or crosslinking agent, the amines (B) mentioned above can be used.

Before removing the solvent from the dispersion liquid (the reaction liquid) obtained after the elongation and/or crosslink reaction, the dispersion liquid is stirred to cause convergence of the particles therein at a constant temperature range lower than the glass transition temperature of the resin in a certain concentration range of the organic solvent, to thereby form cohered particles. After confirming the shapes of the cohered particles, the removal of the solvent is preferably performed at 10° C. to 50° C. By the stirring performed before removing the solvent, the toner is formed to have irregular shapes. This condition as mentioned is not an absolute condition, and hence is appropriately adjusted, if necessary. In the case where the concentration of the organic solvent is high during the granulation, the viscosity of the emulsified liquid is low, and this may cause formations of spherical particles after cohering droplets. In the case where the concentration of the organic solvent is low during the granulation, the viscosity of droplets is high at the time when droplets are combined together, so that a complete single particle cannot be formed from the droplets, and some of them may be left out. To counter this problem, various conditions can be optimized, and by selecting the conditions, the shapes of the toner particles can be appropriately adjusted. Moreover, the shapes of the toner particles can be adjusted by adjusting the amount of the organic-modified layered inorganic mineral. The organic-modified layered inorganic mineral is preferably contained in the solution or dispersion liquid in an amount of 0.05% by mass to 10% by mass based on the solids content. When the amount thereof is smaller than 0.05% by mass, the intended viscosity of the oil phase cannot be attained, so that the intended shapes cannot be attained. In this case, as the viscosity of droplets is low, intended combined particles may not be attained by combining droplets during stirring and cohering, resulting in spherical particles. When the amount thereof is greater than 10% by mass, productivity is poor, and the viscosity of the droplets is excessively high, so that droplets does not form combined particles, which results in poor fixing ability of the resulting toner.

A ratio Dv/Dn of the volume average particle diameter Dv to the number average particle diameter Dn of the toner can be controlled, for example, by adjusting, mainly, the viscosity of the aqueous phase, the viscosity of the oil phase, the characteristics of the resin particles, the amount of the resin particles, and the like. Moreover, Dv and Dn of the toner can be controlled, for example, by adjusting the characteristics of the resin particles, the amount of the resin particles, and the like.

In order to remove the organic solvent from the obtained emulsified dispersion liquid, such a method is employed that the entire liquid is gradually heated to completely evaporate and remove the organic solvent contained in the dispersed droplets. It is also possible that the emulsified dispersion liquid is sprayed in a dry atmosphere to completely evaporate and remove the water-insoluble organic solvent in the droplets to thereby form toner particles, at the same time as evaporating and removing the aqueous dispersant. As for the dry atmosphere in which the emulsified dispersion liquid is sprayed, heated gas (e.g., air, nitrogen, carbon dioxide and combustion gas), especially, gas flow heated to a temperature equal to or higher than the boiling point of the solvent for use, is generally used. By removing the organic solvent even in a short time using, for example, a spray dryer, a belt dryer or a rotary kiln, the resultant product has satisfactory quality.

In the case where the particle size distribution of the emulsified and/or dispersed particles is broad, and washing and drying are performed on the particles with the same broad particle size distribution, the particle size distribution of the washed and dried particles can be controlled to have the predetermined particle size distribution by classification.

Classification is performed by removing very fine particles using a cyclone, a decanter, a centrifugal separator, etc. in the liquid. Needless to say, classification may be performed on powder obtained after drying but is preferably performed in the liquid from the viewpoint of high efficiency. In this case, the fine particles or coarse particles may be in the wet state.

The used dispersing agent is preferably removed from the obtained dispersion liquid to the greatest extent possible. Preferably, the dispersing agent is removed at the same time as the above-described classification is performed.

The resultant dry toner particles may be mixed with other particles such as releasing agent fine particles, charge controlling agent fine particles and colorant fine particles, and also a mechanical impact may be applied to the mixture for immobilization or fusion of other particles on the toner surface, to thereby prevent the other particles from dropping off from the surfaces of the toner particles.

Specific examples of the method for mixing or applying a mechanical impact include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate. Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

<Production Method of Toner according to Emulsification Aggregation Fusion Method>

The emulsification aggregation fusion method include: mixing a resin particle dispersion liquid, which has been prepared by emulsification dispersion, a separately prepared colorant dispersion liquid, and optionally a releasing agent dispersion liquid to cause aggregation to thereby prepare an aggregated particle dispersion liquid in which aggregated particles are formed (may also referred to as an “aggregation step” hereinafter), and heating and fusing the aggregated particles to form toner particles (may also referred to as a “fusing step” hereinafter).

In the aggregation step, the aggregated particles are formed by heteroaggregation or the like. During the formation of the aggregated particles, an ionic surfactant having the opposite polarity to that of the aggregated particles, and/or a compound having a monovalent or higher electric charge, such as a metal salt may be added for the purpose of stabilizing the aggregated particles, and controlling the particle diameters and/or particle size distribution of the aggregated particles. In the fusing step, heating is performed at the temperature equal to or higher than the glass transition temperature of the resin contained in the aggregated particles to fuse the aggregated particles.

Prior to the fusing step, a deposition step may be performed. The deposition step is adding and mixing a dispersion liquid of other fine particles to the aggregated particle dispersion liquid to uniformly deposit fine particles on surfaces of the aggregated particles to form deposited particles.

The fused particles formed by fusing in the fusing step are present as a color fused particle dispersion liquid in the aqueous medium. In a washing step, the fused particles are separated from the aqueous medium, at the same time as removing the impurities and the like mixed in each steps. The separated particles are then dried to thereby obtain, as a powder, a toner for developing electrostatic images.

In the washing step, acidic water, or base water in some cases, is added to fused particles in an amount that is a few times the amount of the fused particles, and the resultant is stirred, followed by filtering the resultant to separate a solid component. To this, pure water is added in an amount that is a few times the amount of the solid component, and the resultant is stirred, followed by filtration. This operation is repeated few times until pH of the filtrate after filtration becomes approximately 7, to thereby obtain colored toner particles. In the drying step, the toner particles obtained in the washing step is dried at the temperature lower than the glass transition temperature of the toner particles. During the heating, dry air may be circulated, or heating is performed in the vacuumed condition, if necessary.

The fusing is performed by heating the aggregated particles at the temperature equal to or higher than the glass transition temperature of the resin contained in the aggregated particles. In the case where the crystalline polyester resin and the non-crystalline polyester resin are used in combination, they become the compatible state by the heating. Therefore, an annealing is desirably performed in the process of the toner production. The annealing can be performed before or during the washing step, or during or after the drying step.

In order to stabilize the dispersibilities of the resin particle dispersion liquid, the colorant dispersion liquid, and the releasing agent dispersion liquid, an emulsifying agent such as an alicyclic compound of an organic acid metal salt can be used. In the case where the dispersion liquid is not necessarily stable in the base, due to the stability owing to pH of the colorant dispersion liquid, releasing agent dispersion liquid or the like, or because of the stability of the resin particle dispersion liquid over time, a small amount of a surfactant can be used.

Examples of the surfactant include: an anionic surfactant such as a sulfuric acid ester salt-based surfactant, a sulfonic acid salt-based surfactant, a phosphoric acid ester-based surfactant, and a soap-based surfactant; a cationic surfactant such as an amine salt-based surfactant, a quaternary ammonium salt-based surfactant; and an nonionic surfactant such as a polyethylene glycol-based surfactant, an alkylphenol ethylene oxide adduct-based surfactant, and a polyhydric alcohol-based surfactant. These may be used independently, or in combination. Among them, the ionic surfactant is preferable, and the anionic surfactant and the cationic surfactant are more preferable.

Since the anionic surfactant generally has strong dispersing ability, and is excellent in dispersing resin particles and a colorant, the anionic surfactant is advantageously used as a dispersant for dispersing the releasing agent in the production of the toner of the present invention. The nonionic surfactant is preferably used in combination with the anionic surfactant or cationic surfactant. The surfactant may be used independently, or in combination.

Examples of the anionic surfactant include: fatty acid soaps such as potassium laurate, sodium oleate, and caster oil sodium salt; sulfuric acid esters such as octyl sulfate, lauryl sulfate, lauryl ether sulfate, and nonylphenyl ether sulfate; sulfonic acid salts such as lauryl sulfonate, dodecylbenzene sulfonate, alkylnaphthalene sulfonate (e.g. triisopropylnaphthalene sulfonate, and dibutylnaphthalene sulfonate), naphthalene sulfonate-formalin condensate, monooctylsulfosuccinate, dioctylsulfosuccinate, lauric acid amide sulfonate, and oleic acid amide sulfonate; phosphoric acid esters such as lauryl phosphate, isopropyl phosphate, and nonylphenyl ether phosphate; and sulfosuccinic acid salts such as dialkylsulfosuccinic acid salts (e.g. sodium dioctylsulfosuccinate), and 2-sodium lauryl sulfossucinate. These may be used independently, or in combination.

Examples of the cationic surfactant include: amine salts such as lauryl amine hydrochloride, stearyl amine hydrochloride, oleyl amine hydrochloride, stearyl amine acetate, and stearylaminopropyl amine acetate; and quaternary ammonium salts such as lauryl trimethyl ammonium chloride, dilauryl dimethyl ammonium chloride, distearyl ammonium chloride, distearyl dimethyl ammonium chloride, lauryl dihydroxyethylmethyl ammonium chloride, oleyl bispolyoxyethylene methyl ammonium chloride, lauroyl aminopropyl dimethyl ethyl ammonium ethosulfate, lauroyl aminopropyl dimethyl hydroxyethyl ammonium perchlorate, alkylbenzene dimethyl ammonium chloride, and alkyltrimethyl ammonium chloride.

Examples of the nonionic surfactant include: alkyl ethers such as polyoxyethylene octyl ether, polyoxyethylene lauryl ether, polyoxyethylene stearyl ether, and polyoxyethylene oleyl ether; alkylphenyl ethers such as polyoxyethylene octylphenyl ether, and polyoxyethylene nonylphenyl ether; alkyl esters such as polyoxyethylene laurate, polyoxyethylene stearate, and polyoxyethylene oleate; alkyl amines such as polyoxyethylene laurylamino ether, polyoxyethylene stearylamino ether, polyoxyethylene oleylamino ether, polyoxyethylene soy-amino ether, and polyoxyethylene beef tallow-amino ether; alkyl amides such as polyoxyethylene lauric acid amide, polyoxyethylene stearic acid amide, and polyoxyethylene oleic acid amide; vegetable oil ethers such as polyoxyethylene caster oil ether, and polyoxyethylene rapeseed oil ether; alkanol amides lauric diethanolamide, stearic diethanolamide, and oleic diethanolamide; and sorbitan ester ethers such as polyoxyethylene sorbitan monolaurate, polyoxyethylene sorbitan monopalmitate, polyoxyethylene sorbitan monostearate, and polyoxyethylene sorbitan monooleate. These may be used independently, or in combination.

An amount of the surfactant in each dispersion liquid is appropriately selected depending on the intended purpose without any restriction, provided that it does not adversely affect the obtainable characteristics of the toner of the present invention. The amount thereof is generally small. Specifically, in the case of the resin particle dispersion liquid, the amount of the surfactant is in the approximate range of 0.01% by mass to 1% by mass, preferably 0.02% by mass to 0.5% by mass, and more preferably 0.1% by mass to 0.2% by mass. When the amount thereof is smaller than 0.01% by mass, aggregation may occur in the state where pH of the resin particle dispersion liquid is not sufficiently basic. In the case of the colorant dispersion liquid and the releasing agent dispersion liquid, an amount of the surfactant is 0.01% by mass to 10% by mass, preferably 0.1% by mass to 5% by mass, and more preferably 0.5% by mass to 0.2% by mass. When the amount thereof is smaller than 0.01% by mass, stability between particles varies during the aggregation and therefore some particles may be isolated. When the amount thereof is greater than 10% by mass, the particle size distribution of the particles is broad, and it may be difficult to control the particle diameters.

To the toner, other than the binder resin, colorant, and releasing agent, particles of other substances, such as internal additive, charge controlling agent, inorganic particles, organic particles, a lubricant, abrasives, and the like can be added depending on the intended purpose.

The internal additive is used in an amount not to adversely affect the electrostatic propensity, which is one of the characteristics of the toner, and is for example a magnetic material, such as a metal (e.g. ferrite, magnetite, reduced iron, cobalt, manganese, and nickel), an alloy, or, a compound containing the preceding metals.

The charge controlling agent is appropriately selected depending on the intended purpose without any restriction, and is preferably a colorless, or pale colored material especially used for a color toner. Examples thereof include a quaternary ammonium salt compound, a nigrosin-based compound, a dye consisted of a complex of aluminum, iron, or chromium, and a triphenylmethane-based pigment.

Examples of the inorganic particles include all the particles generally used as the external additive on a surface of the toner particle, such as silica, titania, calcium cabonate, magnesium carbonate, tricalcium phosphate, and cerium oxide.

Examples of the organic particles include all the particles generally used as the external additive on a surface of the toner such as a vinyl resin, a polyester resin, and a silicone resin. Note that, these inorganic particles and organic particles can be used as a flow improving agent, and cleaning auxiliaries.

Examples of the lubricant include; fatty acid amide such as ethylene bisstearic acid amide, and oleic acid amide; and fatty acid metal salts such as zinc stearate, and calcium stearate. Examples of the abrasives include those mentioned above, such as silica, alumina, and cerium oxide.

When the resin particle dispersion liquid, a dispersion liquid of a layered inorganic mineral at least in part of which has been modified with organic ions, the colorant dispersion liquid, and the releasing agent dispersion liquid are mixed together, an amount of the colorant for use is not particularly restricted as long as it is 50% by mass or smaller, and it is preferably 2% by mass to 40% by mass. An amount of the layered inorganic mineral at least in part of which has been modified with organic ions is preferably 0.05% by mass to 10% by mass. Moreover, amounts of other components are not particularly restricted as long as they do not adversely affect the obtainable effect of the present invention, and are generally very small. Specifically, the total amount of other components is preferably 0.01% by mass to 5% by mass, more preferably 0.5% by mass to 2% by mass.

As a dispersion medium in the resin particle dispersion liquid, the dispersion liquid of the layered inorganic mineral at least in part of which has been modified with organic ions, the colorant dispersion liquid, the releasing agent dispersion liquid, and the dispersion liquid of other components, for example, an aqueous medium is used. Examples of the aqueous medium include: water such as distilled water, and ion-exchanged water; and alcohols. These may be used independently, or in combination.

During the preparation of the aggregated particle dispersion liquid, the emulsifying power of the emulsifying agent is adjusted with pH to thereby allow aggregation to occur so that the resulting aggregated particles can be controlled. At the same time as the above, an aggregating agent may be added in order to stably and promptly form aggregated particles with a narrow particle size distribution. Specific examples of the aggregating agent include: a water-soluble surfactants such as an ionic surfactant, and a nonionic surfactant; acids, such as hydrochloric acid, sulfuric acid, nitric acid, acetic acid, and oxalic acid; metal salts of inorganic acids such as magnesium chloride, sodium chloride, aluminum sulfate, calcium sulfate, ammonium sulfate, aluminum nitrate, silver nitrate, copper nitrate, and sodium carbonate; metal salts of aliphatic acids or aromatic acids, such as sodium acetate, potassium formate, sodium oxalate, sodium phthalate, and potassium salicylate; metal salts of phenols such as sodium phenolate; metal salts of amino acids; and inorganic acid salts of aliphatic or aromatic amines such as triethanol amine hydrochloride, and aniline hydrochloride. In light of the stability of aggregated particles, the stability of the aggregating agent to heat or time-lapse, and the removability during washing, the metal acid of the inorganic acid is preferable as the aggregating agent in terms of its performance, and usability.

An amount of the aggregating agent for use varies depending on the valency of the electric charge, but it is small in any case. In the case of the monovalent aggregating agent, an amount thereof is approximately 3% by mass or smaller. In the case of the bivalent aggregating agent, an amount thereof is approximately 1% by mass or smaller. In the case of the trivalent aggregating agent, an amount thereof is approximately 0.5% by mass or smaller. The smaller amount of the aggregating agent is more preferable.

### <Production Method of Toner by Pulverization Method>

The kneading-pulverization method is a method for producing base particles of the toner by melting and kneading the toner material containing at least the binder resin, the releasing agent, and the fixing aid components, pulverizing the kneaded product, and classifying the pulverized product.

In the melting and kneading (i.e. melt-kneading), materials for forming a toner are mixed to form a toner material (a mixture of the materials), and the toner material is set in a melt-kneader to subject to melt-kneading. As the melt-kneader, for example, monoaxial or biaxial continuous kneader, or a batch-type kneader with a roll mill can be used. Preferable examples thereof include a twin screw extruder KTT manufactured by KOBE STEEL, LTD., an extruder TEM manufactured by TOSHIBA MACHINE CO., LTD., a twin screw extruder manufactured by ASADA WORKS CO., LTD., a twin screw extruder PCM manufactured by Ikegai Corp., and a cokneader manufactured by Buss. The melt-kneading is preferably performed under the appropriate conditions so as not to cause scission of molecular chains of the binder resin. Specifically, the temperature of the melt-kneading is adjusted under taking the softening point of the binder resin as consideration. When the temperature of the melt-kneading is very high compared to the softening point, the scission occurs significantly. When the temperature thereof is very low compared to the softening point, the dispersing may not be progressed.

The pulverizing is pulverizing the kneaded product obtained in the melt-kneading. In the pulverizing, it is preferred that the kneaded product be initially pulverized roughly, and then finely pulverized. For the pulverizing, a method in which the kneaded product is pulverized by making the kneaded product to crush into an impact plate in the jet stream, a method in which particles of the kneaded product are made crushed each other in the jet stream to thereby pulverize the kneaded product, or a method in which the kneaded product is pulverized in a narrow cap between a mechanically rotating rotor and a stator is preferably used.

The classifying is classifying the pulverized product obtained by the pulverizing into particles having the predetermined particle diameters. The classifying can be performed by removing the fine particles component by means of a cyclone, a decanter, a centrifugal separator, or the like.

After the completion of the pulverizing and the classifying, the classified pulverized product is classified in an air stream by centrifugal force or the like to thereby produce toner base particles having the predetermined particle diameters.

Next, external additives are added to the obtained toner base particles. The toner base particles and the external additives are mixed and stirred by means of a mixer to thereby crush the external additives and coat a surface of the toner base particle with the external additives. It is important that the external additive such as inorganic particles and resin particles are uniformly and solidly adhered onto the toner base particles in light of the durability of the resulting toner.

### (Developer)

The developer of the present invention contains at least the toner of the present invention

In the case where the toner of the present invention is used in a two-component developer, the toner is mixed with a magnetic carrier, and the mixing ratio of the carrier and the toner in the developer is preferably such that an amount of the toner is 1 part by mass to 10 parts by mass relative to 100 parts by mass of the carrier.

The magnetic carrier can be selected from conventional magnetic carrier such as iron powder, ferrite powder, magnetite powder and magnetic resin carriers each having a particle diameter of about 20 μm to about 200 μm. As for a coating material for the carrier, amino-based resins are known. Examples of the amino-based resins include urea-formaldehyde resins, melamine resins, benzoguanamine resins, urea resins and polyamide resins.

Other examples of the coating material include: polyvinyl-based resins and polyvinylidene-based resins, such as an acrylic resin, a polymethyl methacrylate resin, a polyacrylonitrile resin, a polyvinyl acetate resin, a polyvinyl alcohol resin, and a polyvinyl butyral resin; polystyrene-based resins such as a polystyrene resin, and a styrene-acryl copolymer resin; halogenated olefin resin such as polyvinyl chloride; polyester-based resins such as a polyethylene terephthalate resin, and a polybutylene terephthalate resin; polycarbonate-based resins; and others such as a polyethylene resins, a polyvinyl fluoride resin, a polyvinylidene fluoride resin, a polytrifluoroethylene resin, a polyhexafluoropropylene resin, a copolymer of vinylidene fluoride and acryl monomer, a copolymer of vinylidene fluoride and vinyl fluoride, fluoroterpolymers (e.g. a terpolymer of tetrafluoroethylene, vinylidene fluoride, and non-fluoride monomer), a silicone resin, and an epoxy resin. These may be used independently, or in combination.

Moreover, the resin coating may contain conductive powder, if necessary. Examples of the material of the conductive powder include metal powder, carbon black, titanium oxide, tin oxide and zinc oxide. The average particle diameter of the conductive powder is preferably 1 μm or smaller. When the average particle diameter thereof is larger than 1 μm, it may be difficult to control the electric resistance.

The toner of the present invention can be used as a one-component magnetic toner or non-magnetic toner without a carrier.

### EXAMPLES

The present invention will be more specifically explained through Examples, hereinafter, but Examples shall not be construed as to limit the scope of the present invention. In the following descriptions, “part(s)” denotes “part(s) by mass”.

In Examples, the acid value, hydroxyl value, melting point, weight average molecular weight, molecular weight distribution, and onset temperature of the crystalline polyester resin were measured in the following manners.

### <Measurement Method of Weight Average Molecular Weight (Mw) of Crystalline Polyester Resin>

The weight average molecular weight of the crystalline polyester resin was measured by the following method.

Gel permeation chromatography (GPC) measuring device: GPC-8220GPC (Tosoh Corporation)

Column: TSKge1 SuperHZM-H, 15 cm, three connected columns (Tosoh Corporation)

Temperature: 40° C.

Solvent: tetrahydrofuran (THF)

Flow rate: 0.35 mL/min

Sample: 0.4 mL of a 0.15% by mass sample to be supplied

Pretreatment of sample: The sample was dissolved in tetrahydrofuran (THF containing a stabilizer, manufactured by Wako Chemical Industries, Ltd.) to give a concentration of 0.15% by mass, the resulting solution was then filtered through a filter having a pore size of 0.2 μm, and the filtrate from the filtration was used as a sample. The measurement was performed by supplying 100 μl of the tetrahydrofuran (THF) sample solution. For the measurement of the molecular weight of the sample, the molecular weight distribution of the sample was calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene were used. As the detector, a refractive index (RI) detector was used.

### <Melting Point of Crystalline Polyester Resin>

The melting point of the crystalline polyester resin was measured by the following method using a DSC system (differential scanning calorimeter) (Q-200, manufactured by TA INSTRUMENTS JAPAN INC.).

At first, an aluminum sample container was charged with about 5.0 mg of the resin, and the holder unit was set in an electric furnace. The sample container was placed on a holder unit, and set in an electric furnace. Next, in a nitrogen atmosphere (flow rate: 50 mL/min), the sample was heated from −20° C. to 150° C. at a temperature increasing rate of 1° C./min, temperature modulation cycle of 60 seconds, and temperature modulation amplitude of 0.159° C. Thereafter, the sample was cooled from 150° C. to 0° C. at a temperature decreasing rate of 10° C./min. In this process, a DSC curve of the sample was measured with a differential scanning calorimeter (Q-200, TA INSTRUMENTS JAPAN INC.). From the obtained the DSC curve, an endothermic peak of the DSC curve during the initial temperature elevation was determined as a melting point of the crystalline polyester resin.

### <Measurement of Acid Value>

The acid value was measured in accordance with the measuring method specified in JIS K0070-1992 under the following conditions.

Specifically, at first, 0.5 g of a sample (0.3 g of the ethyl acetate soluble component) was added to 120 mL of toluene, and the mixture was stirred at about 10 hours at 23° C. to thereby dissolve the sample. To this, 30 mL of ethanol was further added to thereby prepare a sample solution.

Then, an acid value of the sample was measured at 23° C. by means of a potentiometric automatic titrator DL-53 (product of Mettler-Toledo K.K.) and an electrode DG113-SC (product of Mettler-Toledo K.K.), and the result was analyzed using an analysis software LabX Light Version 1.00.000.

For the calibration of the device, a mixed solvent of toluene (120 mL) and ethanol (30 mL) was used.

The measurement conditions for this were the same as those in the measurement of the hydroxyl value.

The acid value could be measured in the manner described above, but specifically, the sample solution was titrated with a pre-standardized 0.1N potassium hydroxide/alcohol solution and then the acid value was calculated from the titration value based on the following formula:

Acid value [KOHmg/g]=titration value [mL]×N×56.1 [mg/mL]/mass of sample [g] (N is a factor of 0.1N potassium hydroxide/alcohol solution)

### <Measurement of Hydroxyl Value>

The hydroxyl value of the crystalline polyester resin was measured in accordance with the method described in JIS K0070-1966 under the following conditions.

A sample (0.5 g) was accurately weighed in a 100 mL measuring flask, and then 5 mL of an acetylation reagent was added thereto. Thereafter, the measuring flask was heated for 1 hour to 2 hours in a hot water bath set to 100° C.±5° C., and was then taken out from the hot water bath and left to cool. Then, the flask was shaken to decompose acetic anhydride. In order to decompose acetic anhydride completely, the flask was again heated in the hot water bath for 10 minutes or longer, followed by taking the flask out from the hot water bath and leaving to cool. Thereafter, the wall of the flask was washed well with an organic solvent. This liquid was subjected to potentiometric titration with N/2 potassium hydroxide ethylalcohol solution using the electrode to thereby determine a hydroxyl value.

### <Onset Temperature of Crystalline Polyester Resin>

The onset temperature was measured by means of a measuring device, TA-60WS and DSC-60 of Shimadzu Corporation under the following measurement conditions.

### [Measurement Conditions]

Sample container: aluminum sample pan (with a lid)

Amount of sample: 5 mg

Reference: aluminum sample pan (housing 10 mg of alumina)

Atmosphere: nitrogen (flow rate of 50 mL/min)

Temperature condition

Starting temperature: 20° C.

Temperature increase rate: 10° C./min

Finish temperature: 150° C.

Retention Time: None

Temperature decrease rate: 10° C./min

Finish temperature: 20° C.

Retention time: None

Temperature increase rate: 10° C./min

Finish temperature: 150° C.

The measured results were analyzed using a data analysis software (TA-60, version 1.52) of Shimadzu Corporation. The onset temperature means a temperature at the intersection between the base line and a tangent line drawn at the point at which a peak curve of the endothermic peak derived from the endothermic peak of the crystalline polyester resin gives the maximum derivative (see FIG. 1).

### Production Example 1

### Synthesis of Crystalline Polyester Resin 2

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 6.9 g of hydroquinone, and the mixture was allowed to for 10 hours at 180° C., then for 4 hours at 200° C., followed by reacting for 5 hours at 8.3 kPa to thereby synthesize Crystalline Polyester Resin 2. The DSC thermal characteristics (melting point), weight average molecular weight Mw as measured by GPC, molecular weight distribution, acid value, hydroxyl value, and onset temperature of Crystalline Polyester Resin 2 are presented in Tables 1-1 and 1-2.

### Production Example 2

### Synthesis of Crystalline Polyester Resin 1

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 2.9 g of hydroquinone, and the mixture was allowed to for 30 hours at 180° C., then for 10 hours at 200° C., followed by reacting for 15 hours at 8.3 kPa to thereby synthesize Crystalline Polyester Resin 1. The DSC thermal characteristics (melting point), weight average molecular weight Mw as measured by GPC, molecular weight distribution, acid value, hydroxyl value, and onset temperature of Crystalline Polyester Resin 1 are presented in Tables 1-1 and 1-2.

### Production Example 3

### Synthesis of Crystalline Polyester Resin 3

A 5 L four-neck flask equipped with a nitrogen-introducing pipe, a drainpipe, a stirrer and a thermocouple was charged with 2,500 g of 1,12-decanediol, 2,330 g of 1,8-octanedioic acid, and 8.9 g of hydroquinone, and the mixture was allowed to for 6 hours at 180° C., then for 3 hours at 200° C., followed by reacting for 4 hours at 8.3 kPa to thereby synthesize Crystalline Polyester Resin 3. The DSC thermal characteristics (melting point), weight average molecular weight Mw as measured by GPC, molecular weight distribution, acid value, hydroxyl value, and onset temperature of Crystalline Polyester Resin 3 are presented in Tables 1-1 and 1-2.

### Production Example 4

### Synthesis of Crystalline Polyester Resin 4

A 5 L four-neck flask equipped with a nitrogen-introducing pipe, a drainpipe, a stirrer and a thermocouple was charged with 2,160 g of fumaric acid, 2,320 g of 1,6-hexanediol, and 4.9 g of hydroquinone, and the mixture was allowed to react for 8 hours at 180° C., and then the mixture was heated to 200° C. and reacted for 1 hour, followed by reacting for 2 hours at 8.3 kPa to thereby Synthesize Crystalline Polyester Resin 4. The DSC thermal characteristics (melting point), weight average molecular weight Mw as measured by GPC, molecular weight distribution, acid value, hydroxyl value, and onset temperature of Crystalline Polyester Resin 4 are presented in Tables 1-1 and 1-2.

TABLE 1-1

| | | | Proportion of | Proportion of | | |
|---|---|---|---|---|---|---|
| | Melting | | Mn being 500 | Mn being | | Hydroxyl |
| | point | | or smaller | 1,000 or | Acid value | value |
| | (° C.) | Mw | (%) | smaller (%) | (mgKOH/g) | (mgKOH/g) |
| Crystalline | 64 | 5,750 | 2.2 | 4.6 | 28 | 3.5 |
| Polyester 1 | | | | | | |
| Crystalline | 70 | 19,200 | 1.2 | 2.8 | 21 | 3.0 |
| Polyester 2 | | | | | | |
| Crystalline | 55 | 4,950 | 3.5 | 5.2 | 31 | 3.8 |
| Polyester 3 | | | | | | |
| Crystalline | 79 | 22,100 | 0.5 | 1.5 | 22 | 3.1 |
| Polyester 4 | | | | | | |

TABLE 1-2

| | Onset |
|---|---|
| | temperature |
| | (° C.) |
| Crystalline | 51 |
| Polyester 1 | |
| Crystalline | 54 |
| Polyester 2 | |
| Crystalline | 47 |
| Polyester 3 | |
| Crystalline | 69 |
| Polyester 4 | |

### Example 1-1

### Production Example 5

### Synthesis of Non-Crystalline Polyester 1

### Low Molecular Weight Polyester

A 5 L four-neck flask equipped with a nitrogen-introducing pipe, a drainpipe, a stirrer and a thermocouple was charged with 229 parts of bisphenol A ethylene oxide 2 mole adduct, 529 parts of bisphenol A propylene oxide 3 mole adduct, 100 parts of isophthalic acid, 108 parts of terephthalic acid, 46 parts of adipic acid and 2 parts of dibutyl tin oxide. The mixture was allowed to react for 10 hours at 230° C. under normal pressure, and further reacted for another 5 hours under reduced pressure of 10 mmHg to 15 mmHg. After the reaction, 30 parts of trimellitic anhydride was added to the reaction vessel, and the mixture was allowed to react for 3 hours at 180° C. under normal pressure to thereby synthesize Non-Crystalline Polyester Resin 1.

Non-Crystalline Polyester Resin 1 had the number average molecular weight of 1,800, weight average molecular weight of 5,500, glass transition temperature (Tg) of 50° C., and acid value of 20 mgKOH/g.

### Production Example 6

### Synthesis of Polyester Prepolymer

A reaction vessel equipped with a condenser, a stirrer and a nitrogen-introducing pipe was charged with 682 parts of bisphenol A ethylene oxide 2 mole adduct, 81 parts of bisphenol A propylene oxide 2 mole adduct, 283 parts of terephthalic acid, 22 parts by mass of trimellitic anhydride and 2 parts of dibutyl tin oxide. The resultant mixture was allowed to react for 8 hours at 230° C. under normal pressure and further react for 5 hours at a reduced pressure of 10 mmHg to 15 mmHg, to thereby synthesize Intermediate Polyester 1.

Intermediate Polyester 1 had the number average molecular weight of 2,100, weight average molecular weight of 9,500, glass transition temperature (Tg) of 55° C., acid value of 0.5 mgKOH/g, and hydroxyl value of 51 mgKOH/g.

Next, a reaction vessel equipped with a condenser, a stirrer and a nitrogen-introducing pipe was charged with 410 parts of Intermediate Polyester 1, 89 parts of isophorone diisocyanate and 500 parts of ethyl acetate, and the mixture was allowed to react for 5 hours at 100° C., to thereby synthesize Prepolymer 1. The amount of free isocyanate contained in Prepolymer 1 was 1.53% by mass.

### Production Example 7

### Synthesis of Ketimine

A reaction vessel equipped with a stirring rod and a thermometer was charged with 170 parts of isophorone diisocyanate and 75 parts of methyl ethyl ketone, and the mixture was allowed to react for 5 hours at 50° C., to thereby synthesize Ketimine Compound 1. The amine value of Ketimine Compound 1 was 418.

### Production Example 8

### Preparation of Master Batch (MB)

Water (1,200 parts), carbon black (Printex 35, product of Degussa) [DBP oil absorption amount=42 mL/100 mg, pH=9.5] (540 parts) and a polyester resin (Intermediate Polyester 1 of Production Example 6) (1,200 parts) were mixed together with HENSCHEL MIXER (product of Mitsui Mining Co., Ltd). The resulting mixture was kneaded for 30 minutes at 150° C. with a two-roller mill, and then rolled, cooled and pulverized with a pulverizer, to thereby produce Master Batch 1.

### Production Example 9

### Preparation of Oil Phase

A vessel equipped with a stirring rod and a thermometer was charged with 378 parts of the synthesized Non-Crystalline Polyester Resin 1, 110 parts of microcrystalline wax (Hi-Mic-1090, manufactured by Nippon Seiro Co., Ltd., melting point: 82° C.), 22 parts of a charge controlling agent (CCA) (salicylic acid metal complex E-84, manufactured by Orient Chemical Industries, Ltd.) and 947 parts of ethyl acetate, and the mixture was heated to 80° C. with stirring. The resulting mixture was maintained its temperature at 80° C. for 5 hours and then cooled to 30° C. over 1 hour. Subsequently, the vessel was charged with 500 parts of Master Batch 1 and 500 parts of ethyl acetate, followed by mixing the mixture for 1 hour, to thereby prepare Raw Material Solution 1.

Raw Material Solution 1 (1,324 parts) was poured into a vessel, and the carbon black and wax were dispersed with a bead mill (ULTRA VISCOMILL, manufactured by AIMEX CO., Ltd.) under the following conditions: a liquid feed rate of 1 kg/hr, disc circumferential velocity of 6 m/s, 0.5 mm-zirconium beads packed to 80% by volume, and 3 passes. Next, a 65% by mass ethyl acetate solution of Non-Crystalline Polyester Resin 1 (1,042.3 parts) was added thereto, and passed once with the bead mill under the above conditions, to thereby obtain Pigment-Wax Dispersion Liquid 1. The solids content (130° C., 30 minutes) of Pigment-Wax Dispersion Liquid 1 was 50%.

### Production Example 10

### Preparation of Crystalline Polyester Dispersion Liquid

A 20 L-metal container was charged with 1,600 g of Crystalline Polyester Resin 1, and 11,200 g of ethyl acetate, the mixture was heated at 75° C. to dissolve Crystalline Polyester Resin 1 therein, followed by quenching the resulting solution in an ice-water bath at the rate of 27° C./min. To this, 3,200 g of Non-Crystalline Polyester Resin 1 was added, and the mixture was stirred for 5 hours to dissolve Non-Crystalline Polyester Resin 1 therein. The resultant was dispersed by a bead mill (LMZ2, manufactured by Ashizawa Finetech Ltd.) under the following conditions: 0.3 mm-zirconium beads packed to 85% by volume, 20 passes, and the temperature of the sealing liquid of the bead mill shaft being 18° C., to thereby prepare Crystalline Polyester Dispersion Liquid 1.

Crystalline Polyester Dispersion Liquid 2 was prepared in the same manner as described above, provided that Crystalline Polyester Resin 1 was replaced with Crystalline Polyester Resin 2.

In addition, Crystalline Polyester Dispersion Liquid 3 was prepared in the same manner as described above, provided that Crystalline Polyester Resin 1 was replaced with Crystalline Polyester Resin 3.

### Production Example 11

### Synthesis of Organic Particle Emulsion

A reaction vessel equipped with a stirring rod and a thermometer was charged with 683 parts of water, 11 parts of a sodium salt of sulfuric acid ester of methacrylic acid-ethylene oxide adduct (ELEMINOL RS-30, manufactured by Sanyo Chemical Industries, Ltd.), 138 parts of styrene, 138 parts of methacrylic acid and 1 part of ammonium persulfate, and the resulting mixture was stirred for 15 minutes at 400 rpm to prepare a white emulsion. The obtained emulsion was heated until the internal system temperature reached 75° C., and then was allowed to react for 5 hours. Subsequently, a 1% by mass aqueous ammonium persulfate solution (30 parts) was added to the reaction mixture, followed by aging for 5 hours at 75° C., to thereby prepare an aqueous dispersion liquid (Fine Particle Dispersion Liquid 1) of a vinyl-based resin (a copolymer of styrene/methacrylic acid/sodium salt of sulfuric acid ester of methacrylic acid ethylene oxide adduct). Fine Particle Dispersion Liquid 1 was subjected to the measurement of a volume average particle diameter by a particle size distribution analyzer (LA-920, manufactured by Horiba, Ltd.). The volume average particle diameter thereof was 0.14 μm. Part of Fine Particle Dispersion Liquid 1 was dried to separate the resin component.

### Production Example 12

### Preparation of Aqueous Phase

Water (990 parts), 83 parts of Particle Dispersion Liquid 1, 37 parts of a 48.5% sodium dodecyldiphenyl ether disulfonate aqueous solution (ELEMINOL MON-7, product of Sanyo Chemical Industries Ltd.) and 90 parts of ethyl acetate were mixed together and stirred to obtain an opaque white liquid, which was used as Aqueous Phase 1.

### Production Example 13

### Emulsification and Removal of Solvent

A vessel was charged with 664 parts of Pigment-Wax Dispersion Liquid 1, 109.4 parts of Prepolymer 1, 73.9 parts of Crystalline Polyester Dispersion Liquid 1, and 4.6 parts of Ketimine Compound 1, and the mixture was mixed for 1 minute at 5,000 rpm with a TK homomixer (manufactured by Tokushu Kika Kogyo Co., Ltd.). Thereafter, 1,200 parts of Aqueous Phase 1 was added to the vessel, and the resulting mixture was mixed for 20 minutes at 13,000 rpm with the TK homomixer, to thereby produce Emulsified Slurry 1.

A vessel equipped with a stirrer and a thermometer was charged with Emulsified Slurry 1, followed by removing the solvent from the Emulsified Slurry 1 for 8 hours at 30° C. and aging for 4 hours at 45° C., to thereby produce Dispersion Slurry 1.

### —Washing and Drying—

Dispersion Slurry 1 (100 parts) was filtrated under reduced pressure and then subjected to a series of treatments (1) to (4) described below:

(1): ion-exchanged water (100 parts) was added to the filtration cake, and the mixture was mixed with a TK homomixer (at 12,000 rpm for 10 minutes), followed by filtration;

(2): a 10% aqueous sodium hydroxide solution (100 parts) was added to the filtration cake obtained in (1), and the mixture was mixed with a TK homomixer (at 12,000 rpm for 30 minutes) followed by filtration under reduced pressure;

(3): 10% hydrochloric acid (100 parts) was added to the filtration cake obtained in (2), and the mixture was mixed with a TK homomixer (at 12,000 rpm for 10 minutes) followed by filtration; and

(4): ion-exchanged water (300 parts) was added to the filtration cake obtained in (3), and the mixture was mixed with a TK homomixer (at 12,000 rpm for 10 minutes), followed by filtration, and this operation was performed twice, to thereby produce Filtration Cake 1.

Filtration Cake 1 was dried with an air-circulating drier for 48 hours at 45° C., and was then passed through a sieve with a mesh size of 75 μm, to thereby prepare Toner 1-1.

### Example 1-2

Toner 1-2 of Example 1-2 was produced in the same manner as in Example 1-1, provided that in Production Example 13 of Example 1-1, the amount of Prepolymer 1 was changed from 109.4 parts to 147.7 parts.

### Example 1-3

Toner 1-3 of Example 1-3 was produced in the same manner as in Example 1-1, provided that in Production Example 13 of Example 1-1, the amount of Prepolymer 1 was changed from 109.4 parts to 164.1 parts.

### Example 1-4

Toner 1-4 of Example 1-4 was produced in the same manner as in Example 1-1, provided that Crystalline Polyester Dispersion Liquid 1 was replaced with Crystalline Polyester Dispersion Liquid 2.

### Example 1-5

Toner 1-5 of Example 1-5 was produced in the same manner as in Example 1-1, provided that in Crystalline Polyester Dispersion Liquid 1, Crystalline Polyester Resin 1 was replaced with Crystalline Polyester Resin 4.

### Comparative Example 1-1

Toner 1-5 of Comparative Example 1-1 was produced in the same manner as in Example 1-1, provided that in Production Example 13 of Example 1-1, the amount of Prepolymer 1 was changed from 109.4 parts to 54.7 parts.

### Comparative Example 1-2

Toner 1-6 of Comparative Example 1-2 was produced in the same manner as in Example 1-1, provided that Crystalline Polyester Dispersion Liquid 1 was replaced with Crystalline Polyester Dispersion Liquid 3.

To 100 parts of each of the toner obtained, 0.7 parts of hydrophobic silica and 0.3 parts by mass of hydrophobic titanium oxide were added and mixed by HENSCHEL MIXER. The evaluation results of the obtained toner are presented in Table 2.

Each of the external additive-treated toners (5% by mass) was mixed with 95% by mass of copper-zinc ferrite carrier coated with a silicone resin, and having the average particle diameter of 40 μm to thereby prepare developers.

### <Toner Volume Average Particle Diameter (Dv) and Ratio (Dv/Dn)>

The volume average particle diameter (Dv) and number average particle diameter (Dn) of the toner was measured by means of a particle analyzer (Coulter Multisizer III, manufactured by Beckman Coulter, Inc.) with the aperture diameter of 100 μm, and analyzing using an analysis software (Beckman Coulter Multisizer 3 Version 3.51). Specifically, a 100 mL glass beaker was charged with 0.5 mL of a 10% by mass surfactant (alkylbenzene sulfonate, Neogen SC-A, manufactured by Dai-Ichi Kogyo Seiyaku Co., Ltd.), and to this 0.5 g of each toner was added and stirred by microspartel, followed by adding 80 mL of ion-exchanged water. The obtained dispersion liquid was dispersed with an ultrasonic wave disperser (W-113MK-II, manufactured by Honda Electronics Co., Ltd.) for 10 minutes. The obtained dispersion liquid was subjected to the measurement by Multisizer III using ISOTON III (Beckman Coulter, Inc.) as a reagent. For the measurement, the toner sample dispersion liquid was added dropwise so that the device shows the concentration to be 8%±2%. In this measurement method, it was important that the concentration was set 8%±2% in light of the measurement reproducibility of the particle diameter. As long as the concentration was within this range, there was no error occurred in the particle diameter.

### <Viscoelasticity of Toner>

The storage modulus G′, loss modulus G″, and loss tangent tan δ (loss modulus G″/storage modulus G′) of the toner was measured by means of a stress rheometer (ARES, manufactured by TA Instruments Japan Inc.), using parallel plates, in the following manner.

A sample (0.1 g) was pressed by a pellet forming unit for 1 minute at room temperature (25° C.) and about 40 MPa, to thereby prepare a measurement sample having a diameter of 8 mm.

This measurement sample was placed between the parallel plates each having a diameter of 8 mm, followed by heating to fuse the sample. Thereafter, strain, which gave sinusoidal vibrations in the circumferential direction of the parallel plates, was applied to the sample at the angular frequency of 6.28 rad/sec, and the strain amount of 0.3%, to thereby make the measurement sample cause sinusoidal oscillation. Meanwhile, the temperature was elevated from 60° C. to 200° C. at the rate of 3° C./min, and the storage modulus G′ and loss modulus G″ of the sample was measured at each temperature with the measuring temperature interval of 1° C.

Note that, the values of the loss tangent presented in Table 2 were the loss tangent tan δ (loss modulus G″/storage modulus G′) of each toner at 80° C.

### <Fixing Ability>

A fixing section of a copier MF 2200 (Ricoh Company Limited) was modified to employ a TEFLON (registered trade mark) roller as a fixing roller, and using the modified copier a printing test was performed with Type 6200 paper sheets (product of Ricoh Company, Ltd.).

Specifically, the cold offset temperature (the lowest fixing temperature) and the hot offset temperature (the highest fixing temperature) determined by varying the fixing temperature.

The evaluation conditions for the lowest fixing temperature were set as follows: linear velocity of paper feed: 120 mm/sec to 150 mm/sec, surface pressure: 118 kPa (1.2 kgf/cm²) and nip width: 3 mm.

The evaluation conditions for the highest fixing temperature were set as follows: linear velocity of paper feeding: 50 mm/sec, surface pressure: 196 kPa (2.0 kgf/cm²) and nip width: 4.5 mm.

### <Heat Resistance Storage Stability>

After storing each toner for 8 hours at 50° C., the toner was passed through a sieve of 42-mesh for 2 minutes, and a residual rate of the toner on the wire gauze was measured. Note that, the toner with the better heat resistance storage stability gives the smaller residual rate.

The heat resistance storage stability was judged as: A when the residual rate was lower than 10%; B when the residual rate was 10% or higher but lower than 20%; C when the residual rate was 20% or higher but lower than 30%; and D when the residual rate was 30% or higher.

### <Image Evaluation>

A supply bottle was filled with each toner, and stored for 4 weeks at 30° C. and 60% RH. The developer and the toner supply bottle were used for continuous printing of a solid image on 100 sheets, by means of an image forming apparatus (Imagio Neo 450 of Ricoh Company Limited) which could output 45 sheets (A4 size) per minute. The resulting images were evaluated based on the following criteria.

### [Evaluation Criteria]

A: Uniform and excellent solid image

B: White line in the width of less than 0.3 mm was slightly observed, but it was not clearly shown in the solid image.

C: White line(s) in the width of 0.3 mm or more was observed, and white line was observed in the solid image on less than 20 sheets out of 100 sheets.

D: White line(s) in the width of 0.3 mm or more was observed, and white line was observed in the solid image on 20 sheets or more out of 100 sheets.

Evaluation results of Examples and Comparative Examples are presented in Table 2 below.

TABLE 2

| | | | | | Fixing ability | | Heat resistance | |
|---|---|---|---|---|---|---|---|---|
| | Dv | | Value of | Loss | | Hot offset | storage | Image |
| | [μm] | Dv/Dn | formula 1 | tangent | lowest | resistance | stability | evaluation |
| Ex. 1-1 | 4.7 | 1.12 | 11 | 0.9 | A | B | B | B |
| Ex. 1-2 | 5.1 | 1.09 | 16 | 0.7 | A | A | A | A |
| Ex. 1-3 | 4.8 | 1.00 | 19 | 0.5 | B | A | A | A |
| Ex. 1-4 | 5.2 | 1.09 | 18 | 0.8 | B | A | A | A |
| Ex. 1-5 | 5.0 | 1.09 | 5 | 0.8 | B | A | A | A |
| Comp. | 4.4 | 1.10 | 12 | 1.5 | A | D | D | D |
| Ex. 1-1 | | | | | | | | |
| Comp. | 4.9 | 1.11 | 22 | 0.8 | A | C | A | C |
| Ex. 1-2 | | | | | | | | |

### Example 2-1

### Production Example 14

### Synthesis of Non-Crystalline Polyester Resin 2

A two-necked flask, which had been heated and dried, was charged with 780 mole parts of polyoxypropylene(2,2)-2,2-bis(4-hydroxyphenyl)propane, 18 mole parts of polyoxyethylene(2,2)-2,2-bis(4-hydroxyphenyl)propane, 47 mole parts of terephthalic acid, 24 mole parts of fumaric acid, and 24 mole parts of n-dodecenyl succinic acid as raw materials, and dibutyl tin oxide as a catalyst, and heated while introducing nitrogen gas to maintain an inert atmosphere. Thereafter, the mixture was reacted to proceed to a condensation copolymerization reaction for 12 hours at 230° C., followed by gradually reducing the pressure at 230° C. to thereby synthesize Non-Crystalline Polyester Resin 2.

Non-Crystalline Polyester Resin 2 had the number average molecular weight of 6,700, weight average molecular weight of 17,400, glass transition temperature (Tg) of 61° C., and acid value of 14 mgKOH/g.

### (Formulation of Toner Material)

| | | |
|---|---|---|
| Binder resin: Crystalline Polyester Resin 1 | 8 | parts |
| Binder resin: Non-Crystalline Polyester Resin 2 | 86 | parts |
| Colorant: Carbon black C-44 | 7 | parts |
| (manufactured by Mitsubishi Chemical Corporation, average | | |
| particle diameter: 24 nm, BET specific surface area: 125 | | |
| m²/g) | | |
| Charge controlling agent (CCA): BONTRON E-84 | 1 | part |
| (manufactured by ORIENT CHEMICAL INDUSTRIES CO., | | |
| LTD) | | |
| Microcrystalline Wax: Hi-mic-1090 | 6 | parts |
| (manufactured by Nippon Seiro Co., Ltd, melting point: | | |
| 82° C.) | | |

Using a super mixer (SMV-200, manufactured by KAWATA MFG Co. Ltd.), the materials of the formulation above were sufficiently mixed, to thereby obtain a mixture of the material for the toner, i.e. a toner material. The obtained toner material was supplied to Buss cokneader (TCS-100, Buss) through a raw material supplying hopper, and was kneaded at the feeding rate of 120 kg/h.

After rolling and cooling the obtained kneaded product by a double belt cooler, the resultant was roughly grinded by a hammer mill, followed by fine grinding by means of jet flow grinder (I-20 Jet Mill, manufactured by Nippon Pneumatic Mfg. Co., Ltd.). Thereafter, the resultant was subjected to classification of a fine powder by means of a wind classifier (DS-20, DS-10 separator, manufactured by Nippon Pneumatic Mfg. Co., Ltd.). Then, the obtained product from the classification was left to stand for 24 hours at 50° C. for annealing.

### Example 2-2

Toner 2-2 of Example 2-2 was produced in the same manner as in Example 2-1, provided that Crystalline Polyester Resin 1 was replaced with Crystalline Polyester Resin 2.

### Comparative Example 2-1

Toner 2-3 of Comparative Example 2-1 was produced in the same manner as in Example 2-1, provided that Crystalline Polyester Resin 1 was replaced with Crystalline Polyester Resin 3.

### Comparative Example 2-2

Toner 2-4 of Comparative Example 2-2 was produced in the same manner as in Example 2-1, provided that annealing was not performed.

To 100 parts by mass of each of the toner obtained, 0.7 parts by mass of hydrophobic silica and 0.3 parts by mass of hydrophobic titanium oxide were added and mixed by HENSCHEL MIXER.

The obtained toners were each evaluated in terms of various characteristics thereof in the same methods as described above. The results are presented in Table 3.

TABLE 3

| | | | | | Heat | |
|---|---|---|---|---|---|---|
| | | | Fixing ability | | resistance | Image |
| | Value of | Loss | | Hot offset | storage | evalua- |
| | formula 1 | tangent | lowest | resistance | stability | tion |
| Ex. 2-1 | 8 | 0.9 | A | B | B | B |
| Ex. 2-2 | 18 | 0.5 | A | A | A | A |
| Comp. | 23 | 1.3 | A | D | D | D |
| Ex. 2-1 | | | | | | |
| Comp. | 6 | 2.5 | A | D | D | D |
| Ex. 2-2 | | | | | | |

### Example 3-1

### Preparation of Crystalline Polyester Dispersion Liquid

A stainless steel beaker was charged with 180 parts of Crystalline Polyester Resin 1, and 585 parts of deionized water, and the mixture was heated to 95° C. by placing the beaker in a hot water bath.

When Crystalline Polyester Resin 1 was dissolved in water and the solution became clear, a 1% ammonium water was added to the solution to adjust pH thereof to 7.0 while stirring at 10,000 rpm by means of T.K. ROBOMIX (manufactured by PRIMIX Corporation). Subsequently, emulsification dispersion was performed by adding 20 parts of an aqueous solution obtained by diluting a mixture of 0.8 parts of an anionic surfactant (NEOGEN R-K, manufactured by Dai-ichi Kogyo Seiyaku Co., Ltd.) and 0.2 parts of a nonionic emulsifier (EMULGEN 950, manufactured by Kao Corporation) dropwise, to thereby Prepare Crystalline Polyester Dispersion Liquid 1 (solids content: 11.9% by mass) having the volume average particle diameter of 0.22 μm.

### (Preparation of Non-Crystalline Polyester Dispersion Liquid)

Non-Crystalline Polyester Dispersion Liquid 2 (solids content: 12.3% by mass) was prepared in the same manner as in the preparation of Crystalline Polyester Dispersion Liquid 1, provided that Crystalline Polyester Resin 1 was replaced with Non-Crystalline Polyester Resin 2.

### (Preparation of Pigment Dispersion Liquid)

A vessel was charged with 20 parts of carbon black (MA100S, manufactured by Mitsubishi Chemical Corporation), 80 parts of ion-exchanged water, and 4.0 parts of an anionic surfactant (NEOGEN R-K, manufactured by Dai-ichi Kogyo Seiyaku Co., Ltd.), and the pigment was dispersed by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 15 passes, to thereby obtain Pigment Dispersion Liquid 1 (solids content: 19.8% by mass) having the volume average particle diameter of 0.07 μm.

### (Preparation of Wax Dispersion Liquid)

Microcrystalline wax (Hi-mic-1090, Nippon Seiro Co., Ltd. melting point: 82° C.) (20 parts), 80 parts of ion-exchanged water, and 4 parts of an anionic surfactant (NEOGEN R-K, manufactured by Dai-ichi Kogyo Seiyaku Co., Ltd.) were mixed together and the mixture was heated to 95° C. while stirring and the temperature was maintained at 95° C. for 1 hour. Thereafter, the resultant was cooled, and the wax was dispersed therein by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 25 passes, to thereby prepare Wax Dispersion Liquid 1 (solids content: 20.8% by mass) having the volume average particle diameter of 0.15 μm.

### (Preparation of Charge Controlling Agent (CCA) Dispersion Liquid)

A vessel was charged with 5 parts of a charge controlling agent (CCA) (BONTRON E-84, manufactured by Orient Chemical Industries Co., Ltd.), 95 parts of ion-exchanged water, and 0.5 parts of an anionic surfactant (NEOGEN R-K, manufactured by Dai-ichi Kogyo Seiyaku Co., Ltd.), and the charge controlling agent was dispersed therein by means of a bead mill (ULTRA VISCOMILL, manufactured by AIMEX CO., Ltd.) under the following conditions: a liquid feed rate of 1 kg/hr, disc circumferential velocity of 6 m/s, 0.3 mm-zirconium beads packed to 80% by volume, and 5 passes, to thereby obtain Charge Controlling Agent (CCA) Dispersion Liquid 1 (solids content: 4.8% by mass).

### (Preparation Method of Toner)

The following components were mixed and stirred for 2 hours at 25° C. by means of a disperser.

| | |
|---|---|
| Pigment Dispersion Liquid 1 | 35.4 parts |
| Charge Controlling Agent (CCA) Dispersion Liquid 1 | 20.8 parts |
| Crystalline Polyester Dispersion Liquid 1 | 67.2 parts |
| Non-Crystalline Polyester Dispersion Liquid 1 | 634.1 parts |
| Wax Dispersion Liquid 1 | 28.8 parts |

The resulting dispersion liquid was heated up to 60° C., and the pH thereof was adjusted to 7.0 with ammonium. Then, the dispersion liquid was further heated to 90° C., and the temperature was maintained for 6 hours. Thereafter, the dispersion liquid was cooled to 50° C., and the temperature was maintained for 24 hours at 50° C. to perform annealing, to thereby obtain Dispersion Slurry 2.

Dispersion Slurry 2 (100 parts) was filtrated under reduced pressure and then subjected a series of treatments (1) to (3) described below:

(1): ion-exchanged water (100 parts) was added to the filtration cake, followed by mixing with a TK homomixer (at 12,000 rpm for 10 minutes) and then filtration;

(2): 10% hydrochloric acid was added to the filtration cake obtained in (1) to adjust the pH thereof to 2.8, followed by mixing with a TK homomixer (at 12,000 rpm for 10 minutes) and then filtration; and

(3): ion-exchanged water (300 parts) was added to the filtration cake obtained in (2), followed by mixing with a TK homomixer (at 12,000 rpm for 10 minutes) and then filtration, and this operation was performed twice, to thereby produce Filtration Cake 2.

Filtration Cake 2 was dried with an air-circulating drier at 45° C. for 48 hours, and then was passed through a sieve with a mesh size of 75 μm, to thereby prepare Toner 3-1 having the volume average particle diameter Dv of 5.9 p.m.

### Example 3-2

Toner 3-2 of Example 3-2 was produced in the same manner as in Example 3-1, provided that Crystalline Polyester Resin 1 was replaced with Crystalline Polyester Resin 2.

### Comparative Example 3-1

Toner 3-3 of Comparative Example 3-1 was produced in the same manner as in Example 3-1, provided that Crystalline Polyester Resin 1 was replaced with Crystalline Polyester Resin 3.

### Comparative Example 3-2

Toner 3-4 of Comparative Example 3-2 was produced in the same manner as in Example 3-1, provided that annealing was not performed.

To 100 parts of each of the toner obtained, 0.7 parts of hydrophobic silica and 0.3 parts of hydrophobic titanium oxide were added and mixed by HENSCHEL MIXER.

The obtained toners were each evaluated in terms of various characteristics thereof in the same methods as described above. The results are presented in Table 4.

TABLE 4

| | | | | | Heat | |
|---|---|---|---|---|---|---|
| | | Loss | Fixing ability | | resistance | |
| | Value of | tan- | | Hot offset | storage | Image |
| | formula 1 | gent | lowest | resistance | stability | evaluation |
| Ex. 3-1 | 11 | 0.8 | A | B | B | B |
| Ex. 3-2 | 17 | 0.6 | A | A | A | A |
| Comp. | 25 | 1.2 | A | D | D | D |
| Ex. 3-1 | | | | | | |
| Comp. | 8 | 2.3 | A | D | D | D |
| Ex. 3-2 | | | | | | |

1. A toner comprising:
a binder resin comprising a non-crystalline polyester resin and a crystalline polyester resin;
a colorant; and
a wax,
wherein the toner satisfies Formula 1, and has a loss tangent of 1 or smaller at 80° C. or higher,
B−A<20 Formula 1
wherein A represents a melting point of the crystalline polyester resin and B represents a temperature at which the toner has storage modulus G′ of 20,000 Pa.

2. The toner according to claim 1, wherein the crystalline polyester resin is of an amount of 1 part by mass to 15 parts by mass relative to 100 parts by mass of the binder resin.

3. The toner according to claim 1, wherein the toner is obtained by a method comprising:
dispersing, in an aqueous medium, an oil phase in which an organic solvent comprises the binder resin comprising the crystalline polyester resin and the non-crystalline polyester resin thereby preparing an O/W dispersion liquid; and
removing the organic solvent from the O/W dispersion liquid.

4. The toner according to claim 3, wherein the toner is obtained by the method comprising:
dispersing, in the aqueous medium comprising a dispersant, the oil phase in which at least the colorant, the wax, the crystalline polyester resin, a compound comprising an active hydrogen group, and a binder resin precursor comprising a site reactive with the compound comprising an active hydrogen group are dissolved or dispersed in the organic solvent, thereby preparing an emulsified dispersion liquid;
allowing the binder resin precursor and the compound comprising an active hydrogen group to react in the emulsified dispersion liquid; and
removing the organic solvent from the emulsified dispersion liquid.

5. The toner according to claim 1, wherein the toner is obtained by a method comprising:
melting and kneading a toner material comprising the binder resin, the crystalline polyester resin, the colorant, and the wax, thereby preparing a melt-kneaded product;
pulverizing the melt-kneaded product to prepare a pulverized product; and
classifying the pulverized product,
wherein the method further comprises annealing at an onset temperature of ±5° C., and the onset temperature is calculated from a DSC curve of the crystalline polyester resin as measured by a differential scanning calorimeter with an elevating temperature.

6. The toner according to claim 1, wherein the toner is obtained by a method comprising:
dispersing the crystalline polyester resin in a first aqueous media to obtain crystalline polyester resin particles and the non-crystalline polyester resin in a second aqueous media to obtain non-crystalline polyester resin particles;
mixing the crystalline polyester resin particles, the non-crystalline polyester resin particles, a wax agent dispersion liquid in which a releasing agent is dispersed, and a colorant dispersion liquid in which the colorant is dispersed, thereby preparing a dispersion liquid in which aggregated particles are dispersed;
fusing and cohering the aggregated particles to form toner particles; and
washing the toner particles.

7. The toner according to claim 6, wherein the method further comprises annealing at an onset temperature of ±5° C., and the onset temperature is calculated from a DSC curve of the crystalline polyester resin as measured by a differential scanning calorimeter with an elevating temperature.

8. The toner according to claim 1, wherein the crystalline polyester resin has a melting point of from 60° C. to 80° C.

9. The toner according to claim 1, wherein the toner satisfies the following expressions:
10 mgKOH/g<X<40 mgKOH/g
0 mgKOH/g<Y<20 mgKOH/g
20 mgKOH/g<X+Y<40 mgKOH/g
wherein X represents an acid value of the crystalline polyester resin, and Y represents a hydroxyl value of the crystalline polyester resin.

10. The toner according to claim 1, wherein the toner satisfies the following expression:
−10 mgKOH/g<X−Z<10 mgKOH/g
wherein X represents an acid value of the crystalline polyester resin, and Z represents an acid value of the non-crystalline polyester resin.

11. The toner according to claim 1, wherein the crystalline polyester resin is prepared by a process comprising: reacting a C4-C12 saturated dicarboxylic acid and a C4-C12 saturated diol.

12. The toner according to claim 1, wherein
a proportion of the crystalline polyester resin having a number average molecular weight of 500 or smaller is 0% to 2.0% of the crystalline polyester resin,
a proportion of the crystalline polyester resin having a number average molecular weight of 1,000 or smaller is 0% to 4.0% of the crystalline polyester resin, and
the number average molecular weight of the crystalline polyester resin is measured by GPC.

13. The toner according to claim 1, wherein the wax has a melting point of from 70° C. to 90° C.

14. The toner according to claim 1, wherein the wax is a microcrystalline wax.

15. A developer, comprising:
the toner according to claim 1.
